(19) United States
(12) Patent Application Publication
(10) Pub. No.: US 2012/0079852 A1
(43) Pub. Date: Apr. 5, 2012

(54) Systems and Methods for Removing Heavy Hydrocarbons and Acid Gases From a Hydrocarbon Gas Stream

(76) Inventors: Paul Scott Northrop, Spring, TX (US); Edward L. Kimble, Sugar Land, TX (US); Charles J. Mart, Baton Rouge, LA (US); Paul W. Sibal, The Woodlands, TX (US); Bruce T. Kelley, Kingwood, TX (US)

(21) Appl. No.: 13/376,566

(22) PCT Filed: Jul. 9, 2010
(86) PCT No.: PCT/US2010/041530

§ 371 Date: Dec. 6, 2011

Related U.S. Application Data
(60) Provisional application No. 61/229,994, filed on Jul. 30, 2009.
(60) Provisional application No. 61/357,358, filed on Jun. 22, 2010.

(51) Int. Cl. F25J 3/02; B01D 53/04; B01D 50/00; B01D 53/02

(52) U.S. Cl. 62/620; 55/342; 96/108; 96/130; 96/126; 96/122; 55/342.2

(57) ABSTRACT

A system for removing acid gases from a sour gas stream is provided. The system includes an acid gas removal system and a heavy hydrocarbon removal system. The acid gas removal system receives the sour gas stream and separates the sour gas stream into an overhead gas stream comprised primarily of methane, and a bottom acid gas stream comprised primarily of acid gases such as carbon dioxide. The heavy hydrocarbon removal system may be placed upstream or downstream of the acid gas removal system or both. The heavy hydrocarbon removal system receives a gas stream and separates the gas stream into a first fluid stream comprising heavy hydrocarbons and a second fluid stream comprising other components. The components of the second fluid stream will depend on the composition of the gas stream. Various types of heavy hydrocarbon removal systems may be utilized.

### CROSS REFERENCE

This application claims the benefit of U.S. Provisional Patent Application 61/229,994 filed Jul. 30, 2009 entitled CRYOGENIC SYSTEM FOR REMOVING ACID GASES FROM A HYDROCARBON GAS STREAM, WITH REMOVAL OF HEAVY HYDROCARBONS and U.S. Provisional Patent Application 61/357,358 filed Jun. 22, 2010 entitled SYSTEMS AND METHODS FOR REMOVING HEAVY HYDROCARBONS AND ACID GASES FROM A HYDROCARBON GAS STREAM. The entirety of both applications are incorporated by reference herein by reference for all purposes.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### FIELD

The present invention relates to the field of fluid separation. More specifically, the present invention relates to the separation of both heavy hydrocarbons and acid gases from a light hydrocarbon fluid stream.

### Discussion of Technology

The production of hydrocarbons from a reservoir oftentimes carries with it the incidental production of non-hydrocarbon gases. Such gases include contaminants such as hydrogen sulfide (H₂S) and carbon dioxide (CO₂). When H₂5 and CO₂ are produced as part of a hydrocarbon gas stream (such as methane or ethane), the gas stream is sometimes referred to as “sour gas.”

Sour gas is usually treated to remove CO₂, H₂S, and other contaminants before it is sent downstream for further processing or sale. Removal of acid gases creates a “sweetened” hydrocarbon gas stream. The sweetened stream may be used as an environmentally-acceptable fuel, as feedstock to a chemicals or gas-to-liquids facility, or as gas that may be liquefied into liquefied natural gas, or LNG.

The gas separation process creates an issue as to the disposal of the separated contaminants. In some cases, the concentrated acid gas (consisting primarily of H₂S and CO₂) is sent to a sulfur recovery unit (“SRU”). The SRU converts the H₂S into benign elemental sulfur. However, in some areas (such as the Caspian Sea region), additional elemental sulfur production is undesirable because there is a limited market. Consequently, millions of tons of sulfur have been stored in large, above-ground blocks in some areas of the world, most notably Canada and Kazakhstan.

While the sulfur is stored on land, the carbon dioxide gas associated with the acid gas is oftentimes vented to the atmosphere. However, the practice of venting CO₂ is sometimes undesirable. One proposal to minimizing CO₂ emissions is a process called acid gas injection (“AGI”). AGI means that unwanted sour gases are re-injected into a subterranean formation under pressure and sequestered for potential later use. Alternatively, the carbon dioxide is used to create artificial reservoir pressure for enhanced oil recovery operations.

To facilitate AGI, it is desirable to have a gas processing facility that effectively separates out the acid gas components from the hydrocarbon gases. However, for “highly sour” streams, that is, production streams containing greater than about 15% or 20% CO₂ and/or H₂S, it can be particularly challenging to design, construct, and operate a facility that can economically separate contaminants from the desired hydrocarbons. Many natural gas reservoirs contain relatively low percentages of hydrocarbons (less than 40%, for example) and high percentages of acid gases, principally carbon dioxide, but also hydrogen sulfide, carbonyl sulfide, carbon disulfide and various mercaptans. In these instances, cryogenic gas processing may be beneficially employed.

Cryogenic gas processing is a distillation process sometimes used for gas separation. Cryogenic gas separation generates a cooled overhead gas stream at moderate pressures (e.g., 350-550 pounds per square inch gauge (psig)). In addition, liquefied acid gas is generated as a “bottoms” product. Since liquefied acid gas has a relatively high density, hydrostatic head can be beneficially used in an AGI well to assist in the injection process. This means that the energy required to pump the liquefied acid gas into the formation is lower than the energy required to compress low-pressure acid gases to reservoir pressure. Fewer stages of compressors and pumps are required.

Challenges also exist with respect to cryogenic distillation of sour gases. When CO₂ is present at concentrations greater than about 5 mol. percent at total pressure less than about 700 psig in the gas to be processed, it will freeze out as a solid in a standard cryogenic distillation unit. The formation of CO₂ as a solid disrupts the cryogenic distillation process. To circumvent this problem, the assignee has previously designed various “Controlled Freeze Zone™” (CFZ™) processes. The CFZ™ process takes advantage of the propensity of carbon dioxide to form solid particles by allowing frozen CO₂ particles to form within an open portion of the distillation tower, and then capturing the particles on a melt tray. As a result, a clean methane stream (along with any nitrogen or helium present in the raw gas) is generated at the top of the tower, while a cold liquid CO₂/H₂S stream is generated at the bottom of the tower. At pressures higher than about 700 psig, “bulk fractionation” distillation can be done without fear of CO₂ freezing; however, the methane generated overhead will have at least several percent of CO₂ in it.

Certain aspects of the CFZ™ process and associated equipment are described in U.S. Pat. No. 4,533,372; U.S. Pat. No. 4,923,493; U.S. Pat. No. 5,062,270; U.S. Pat. No. 5,120,338; and U.S. Pat. No. 6,053,007.

As generally described in the above U.S. patents, the distillation tower, or column, used for cryogenic gas processing includes a lower distillation zone and an intermediate controlled freezing zone. Preferably, an upper distillation zone is also included. The column operates to create solid CO₂ particles by providing a portion of the column having a temperature range below the freezing point of carbon dioxide, but above the boiling temperature of methane at that pressure. More preferably, the controlled freezing zone is operated at a temperature and pressure that permits methane and other light hydrocarbon gases to vaporize, while causing CO₂ to form frozen (solid) particles.

As the gas feed stream moves up the column, frozen CO₂ particles break out of the feed stream and gravitationally descend from the controlled freezing zone onto a melt tray. There, the particles liquefy. A carbon dioxide-rich liquid stream then flows from the melt tray down to the lower distillation zone at the bottom of the column. The lower distillation zone is maintained at a temperature and pressure at which substantially no carbon dioxide solids are formed, but dissolved methane boils out. In one aspect, a bottom acid gas stream is created at 30° to 40° F.

The controlled freezing zone includes a cold liquid spray. This is a methane-enriched liquid stream known as “reflux.” As the vapor stream of light hydrocarbon gases and entrained sour gases moves upward through the column, the vapor stream encounters the liquid spray. The cold liquid spray aids in breaking out solid CO₂ particles while permitting methane gas to evaporate and flow upward in the column.

In the upper distillation zone, the methane (or overhead gas) is captured and piped away for sale or made available for fuel. In one aspect, the overhead methane stream is released at about −130° F. The overhead gas may be partially liquefied by additional cooling, and the liquid returned to the column as the reflux. The liquid reflux is injected as the cold spray into the spray section of the controlled freezing zone, generally after flowing through trays or packing of the rectification section of the column. The methane produced in the upper distillation zone meets most specifications for pipeline delivery. For example, the methane can meet a pipeline CO₂ specification of less than 2 mol. percent, as well as a 4 ppm H₂S specification, if sufficient reflux is generated.

However, if the original raw gas stream contains any heavy hydrocarbons (that is, propane, butane, and heavier hydrocarbons), these will end up in the liquid bottom stream of carbon dioxide and hydrogen sulfide of the cold distillation column. The heavy hydrocarbons may have recoverable value if they can be effectively separated from the containing fluid, either upstream or downstream of the cold distillation column.

For example, it may be desirable to remove heavy hydrocarbon components from the raw gas stream before it enters the cold distillation column. This allows a “leaner” gas stream to be fed into the column. There is a need for a system to reduce the content of heavy hydrocarbons from a raw natural gas stream before it undergoes cryogenic distillation for the removal of sour gases. There is also a need for a cryogenic gas separation system and accompanying processes that recover potentially valuable ethane, propane, butane, and other heavy hydrocarbons without mingling the heavy hydrocarbons with acid gases in the bottom stream of a CFZ tower. Additionally or alternatively, there is also need for processes that separate heavy hydrocarbons from concentrated acid gases, as in the bottoms stream of a CFZ tower. The technologies disclosed herein include a variety of systems and methods for separating heavy hydrocarbons from streams, with such technologies being implemented in gas processing systems and methods to remove the heavy hydrocarbons in a manner that allows their recovery and commercialization.

### SUMMARY OF THE INVENTION

A system for removing acid gases from an acid gas stream is provided. In one embodiment, the system includes an acid gas removal system. The acid gas removal system receives the acid gas stream and separates the acid gas stream into an overhead gas stream comprised primarily of methane, and a bottom acid gas stream comprised primarily of carbon dioxide. The raw gas stream comprises at least 5 mol. percent heavy hydrocarbon components.

The system also includes a heavy hydrocarbon removal system. The heavy hydrocarbon removal system may be placed upstream of the acid gas removal system. The heavy hydrocarbon removal system receives a raw gas stream and generally separates the raw gas stream into a heavy hydrocarbon fluid stream and the sour gas (with methane) stream. Additionally or alternatively, the heavy hydrocarbon removal system may be placed downstream of the acid gas removal system. In either event, the heavy hydrocarbons are recovered for commercialization or utilization in one or more processes.

Preferably, the acid gas removal system is a cryogenic system. The acid gas removal system includes a cryogenic distillation tower for receiving the sour gas stream, and a refrigeration system for chilling the sour gas stream before entry into the distillation tower. Preferably, the cryogenic acid gas removal system is a “CFZ” system wherein the distillation tower has a lower distillation zone and an intermediate controlled freezing zone. The intermediate controlled freezing zone, or “spray section,” receives a cold liquid spray comprised primarily of methane. The cold spray is a liquid reflux generated from an overhead loop downstream of the distillation tower. Refrigeration equipment is provided downstream of the cryogenic distillation tower for cooling the overhead methane stream and returning a portion of the overhead methane stream to the cryogenic distillation tower as the cold liquid reflux, which then becomes liquid.

It is understood that other acid gas removal systems besides cryogenic distillation systems may be employed. For example, the acid gas removal system may be a physical solvent process which is also prone to rejecting heavy hydrocarbons along with acid gas components.

Various types of heavy hydrocarbon removal systems may be utilized. These include systems that employ physical solvents to separate heavy hydrocarbons from light gases. These may also include systems that employ membrane contactors, or systems that employ extractive distillation processes. In any instance, chemical solvents are not used for heavy hydrocarbon removal.

In one aspect, the heavy hydrocarbon removal system comprises at least one solid adsorbent bed. When disposed upstream of the acid gas removal system, the at least one solid adsorbent bed adsorbs at least some heavy hydrocarbon components and substantially passes light hydrocarbon components for processing in the acid gas removal system. The solid adsorbent bed may, for example, (i) be fabricated from a zeolite material, or (ii) comprise at least one molecular sieve. The solid adsorbent bed may incidentally adsorb at least some carbon dioxide and/or hydrogen sulfide. In this instance, the heavy hydrocarbon removal system preferably also includes a contaminant clean-up system.

The at least one solid adsorbent bed may be an adsorptive kinetic separations bed. Alternatively, the at least one solid adsorbent bed may comprise at least three adsorbent beds wherein (i) a first of the at least three adsorbent beds is in service for adsorbing heavy hydrocarbon components; (ii) a second of the at least three adsorbent beds undergoes regeneration; and (iii) a third of the at least three adsorbent beds is held in reserve to replace the first of the at least three adsorbent beds. The regeneration may be part of a thermal-swing adsorption process, part of a pressure-swing adsorption process, or a combination thereof.

Additionally or alternatively, the heavy hydrocarbon removal system may comprise a turbo-expander or a cyclonic device for separating the raw gas stream into the heavy hydrocarbon fluid stream and the light gas stream. In the case of the turbo-expander, the heavy hydrocarbon removal system may also include a gravity separator for separating the raw gas stream into the heavy hydrocarbon fluid stream and the light gas stream. In the case of the cyclonic device, the heavy hydrocarbon removal system may also include a contaminant removal system for receiving the heavy hydrocarbon fluid stream and then separating the heavy hydrocarbon fluid stream into hydrocarbon components and carbon dioxide.

Still additionally or alternatively, the systems for removing acid gases from a sour gas stream described herein may include systems adapted remove heavy hydrocarbons downstream from the acid gas removal system. The system is once again designed to process a raw gas stream comprising at least 5 mol. percent heavy hydrocarbon components. Heavy hydrocarbons are removed from the gas stream without the use of a chemical solvent.

In one embodiment, the system includes an acid gas removal system. The acid gas removal system receives the sour gas stream and separates the sour gas stream into an overhead gas stream comprised primarily of methane, and a bottom acid gas stream comprised primarily of carbon dioxide and heavy hydrocarbons.

Preferably, the acid gas removal system is a cryogenic acid gas removal system. The cryogenic acid gas removal system includes a distillation tower for receiving the sour gas stream, and a refrigeration system for chilling the sour gas stream before entry into the distillation tower. More preferably, the cryogenic acid gas removal system is a “CFZ” system wherein the distillation tower has a lower distillation zone and an intermediate controlled freezing zone. The intermediate controlled freezing zone, or “spray section,” receives a cold liquid spray comprised primarily of methane. The cold spray is a liquid reflux generated from an overhead loop downstream of the distillation tower. Refrigeration equipment is provided downstream of the cryogenic distillation tower for cooling the overhead methane stream and returning a portion of the overhead methane stream to the cryogenic distillation tower as liquid reflux.

The system also includes a heavy hydrocarbon removal system. As noted, the heavy hydrocarbon removal system in this case is placed downstream of the acid gas removal system. The heavy hydrocarbon removal system receives the bottom acid gas stream and generally separates the bottom acid gas stream into a heavy hydrocarbon fluid stream and acid gases.

Various types of heavy hydrocarbon removal systems may be utilized, such as those described above in connection with heavy hydrocarbon removal systems upstream of the acid gas removal systems. In one aspect, the heavy hydrocarbon removal system comprises at least one solid adsorbent bed. The at least one solid adsorbent bed adsorbs at least some heavy hydrocarbon components from the bottom acid gas stream and substantially passes acid gas components. The solid adsorbent bed may, for example, (i) be fabricated from a zeolite material, or (ii) comprise at least one molecular sieve. The solid adsorbent bed may incidentally adsorb at least some carbon dioxide. In this instance, the heavy hydrocarbon removal system preferably also includes a separator such as a gravity separator. The gravity separator separates liquid heavy hydrocarbon components from gaseous CO₂, for example.

In another aspect, the heavy hydrocarbon removal system comprises an extractive distillation system for receiving the bottom acid gas stream and separating the bottom acid gas stream into a first fluid stream comprised primarily of carbon dioxide and, perhaps, hydrogen sulfide, and a second fluid stream comprised primarily of heavy hydrocarbon components.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a side view of an illustrative CFZ distillation tower, in one embodiment. A chilled raw gas stream is injected into the intermediate controlled freezing zone of the tower.

FIG. 2A is a plan view of a melt tray, in one embodiment. The melt tray resides within the tower below the controlled freezing zone.

FIG. 2B is a cross-sectional view of the melt tray of FIG. 2A, taken across line 2B-2B.

FIG. 2C is a cross-sectional view of the melt tray of FIG. 2A, taken across line 2C-2C.

FIG. 3 is an enlarged side view of stripping trays in the lower distillation zone of the distillation tower, in one embodiment.

FIG. 4A is perspective view of a jet tray as may be used in either the lower distillation section or in the upper distillation zone of the distillation tower, in one embodiment.

FIG. 4B is a side view of one of the openings in the jet tray of FIG. 4A.

FIG. 5 is a side view of the intermediate controlled freezing zone of the distillation tower of FIG. 1. In this view, two illustrative open baffles have been added to the intermediate controlled freeze zone.

FIG. 6A is a schematic diagram showing a gas processing facility for removing acid gases from a gas stream. In this arrangement, heavy hydrocarbons are removed from a gas stream upstream of an acid gas removal system by means of a physical solvent system.

FIG. 6B provides a more detailed schematic diagram of the physical solvent system of FIG. 6A. The physical solvent system operates to contact a dehydrated gas stream in order to remove heavy hydrocarbons.

FIG. 7 is a schematic diagram showing a gas processing facility for removing acid gases from a gas stream. In this arrangement, heavy hydrocarbons are removed from a gas stream upstream of an acid gas removal system by means of a membrane contactor.

FIG. 8 is a schematic diagram of a gas processing facility. In this arrangement, heavy hydrocarbons are removed from a gas stream upstream of an acid gas removal system by means of an adsorptive bed that utilizes adsorptive kinetic separation.

FIG. 9 is a schematic diagram of a gas processing facility. In this arrangement, heavy hydrocarbons are removed from a gas stream upstream of an acid gas removal system by means of an extractive distillation system.

FIG. 10 is a schematic diagram of a gas processing facility. In this arrangement, heavy hydrocarbons are removed from a gas stream upstream of an acid gas removal system by means of a turbo-expander.

FIG. 11 is a schematic diagram of a gas processing facility. In this arrangement, heavy hydrocarbons are removed from a gas stream upstream of an acid gas removal system by means of a cyclonic device.

FIG. 12 is a schematic diagram of a gas processing facility. In this arrangement, heavy hydrocarbons are removed from a gas stream upstream of an acid gas removal system by means of a thermal swing adsorption system.

FIG. 13 is a schematic diagram of a gas processing facility. In this arrangement, heavy hydrocarbons are removed from a gas stream upstream of an acid gas removal system by means of a pressure swing adsorption system.

FIG. 14 is a schematic diagram of a gas processing facility. In this arrangement, heavy hydrocarbons are removed from a gas stream upstream of an acid gas removal system. Additional heavy hydrocarbons are removed from a bottom acid gas stream downstream of the acid gas removal system.

FIG. 15 is a schematic diagram of a gas processing facility. In this arrangement, heavy hydrocarbons are removed from a gas stream downstream of an acid gas removal system by means of an adsorptive kinetic separation process.

### DETAILED DESCRIPTION OF CERTAIN EMBODIMENTS

### Definitions

As used herein, the term “hydrocarbon” refers to an organic compound that includes primarily, if not exclusively, the elements hydrogen and carbon. Hydrocarbons generally fall into two classes: aliphatic, or straight chain hydrocarbons, and cyclic, or closed ring hydrocarbons, including cyclic terpenes. Examples of hydrocarbon-containing materials include any form of natural gas, oil, coal, and bitumen that can be used as a fuel or upgraded into a fuel.

As used herein, the term “hydrocarbon fluids” refers to a hydrocarbon or mixtures of hydrocarbons that are gases or liquids. For example, hydrocarbon fluids may include a hydrocarbon or mixtures of hydrocarbons that are gases or liquids at formation conditions, at processing conditions or at ambient conditions (15° C. and 1 atm pressure). Hydrocarbon fluids may include, for example, oil, natural gas, coal bed methane, shale oil, pyrolysis oil, pyrolysis gas, a pyrolysis product of coal, and other hydrocarbons that are in a gaseous or liquid state.

The term “mass transfer device” refers to any object that receives fluids to be contacted, and passes those fluids to other objects, such as through gravitational flow. One non-limiting example is a tray for stripping out certain components. A grid packing is another example.

As used herein, the term “fluid” refers to gases, liquids, and combinations of gases and liquids, as well as to combinations of gases and solids, and combinations of liquids and solids.

As used herein, the term “condensable hydrocarbons” means those hydrocarbons that condense at about 15° C. and one atmosphere absolute pressure. Condensable hydrocarbons may include, for example, a mixture of hydrocarbons having carbon numbers greater than 4.

As used herein, the term “heavy hydrocarbons” refers to hydrocarbons having more than one carbon atom. Principal examples include ethane, propane and butane. Other examples include pentane, aromatics, and diamondoids.

As used herein, the term “closed loop refrigeration system” means any refrigeration system wherein an external working fluid such as propane or ethylene is used as a coolant to chill an overhead methane stream. This is in contrast to an “open loop refrigeration system” wherein a portion of the overhead methane stream itself is used as the working fluid.

As used herein, the term “subsurface” refers to geologic strata occurring below the earth's surface.

As used herein, the term “chemical solvent” means a chemical that preferentially absorbs to a selected component within a raw gas stream by means of a chemical reaction wherein a charge is transferred. Non-limiting examples include amines and potassium carbonate which may preferentially bond to H₂S or CO₂.

### DESCRIPTION OF SPECIFIC EMBODIMENTS

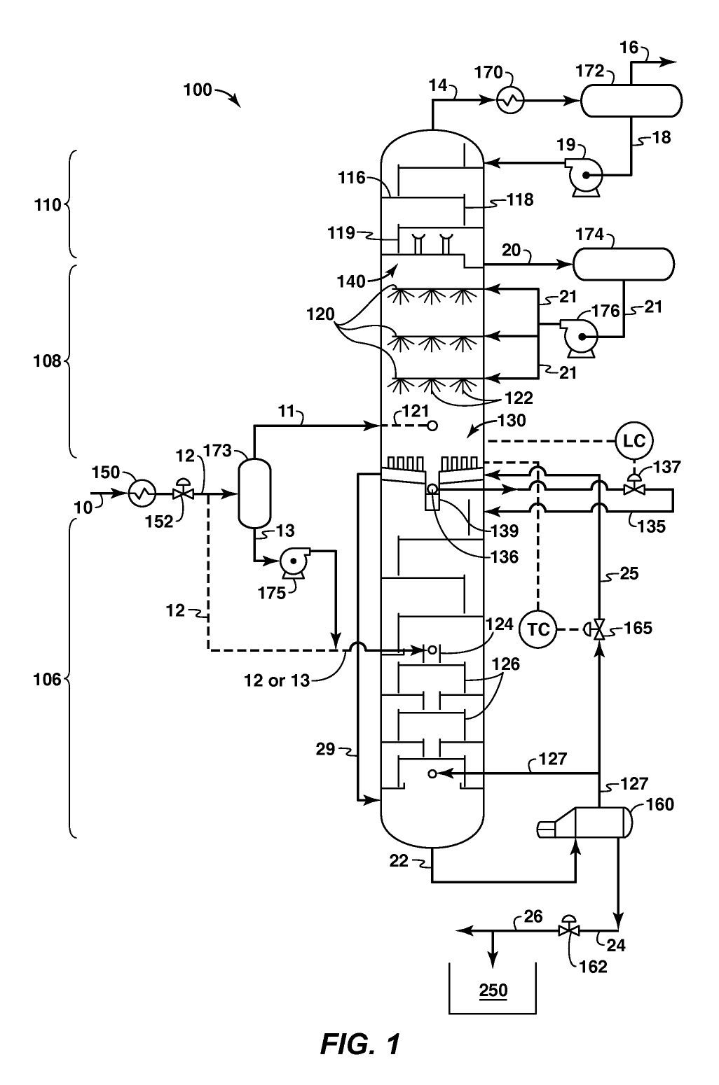

FIG. 1 presents a schematic view of a cryogenic distillation tower 100 as may be used in connection with the present inventions, in one embodiment. The cryogenic distillation tower 100 may be interchangeably referred to herein as a “cryogenic distillation tower,” a “column,” a “CFZ column,” or a “splitter tower.”

The cryogenic distillation tower 100 of FIG. 1 receives an initial fluid stream 10. The fluid stream 10 is comprised primarily of production gases. Typically, the fluid stream represents a dried gas stream from a wellhead or a collection of wellheads (not shown), and contains about 65% to about 95% methane. However, the fluid stream 10 may contain a lower percentage of methane, such as about 30% to 65%, or as low as 20% to 40%.

The methane may be present along with trace elements of other hydrocarbon gases such as ethane. In addition, trace amounts of helium and nitrogen may be present. In the present application, the fluid stream 10 will also include certain contaminants. These include acid gases such as CO₂ and H₂S.

The initial fluid stream 10 may be at a post-production pressure of approximately 600 pounds per square inch (psi). In some instances, the pressure of the initial fluid stream 10 may be up to about 750 psi or even 1,000 psi.

The fluid stream 10 is typically chilled before entering the distillation tower 100. A heat exchanger 150, such as a shell-and-tube exchanger, is provided for the initial fluid stream 10. A refrigeration unit (not shown) provides cooling fluid (such as liquid propane) to the heat exchanger 150 to bring the temperature of the initial fluid stream 10 down to about −30° to −40° F. The chilled fluid stream may then be moved through an expansion device 152. The expansion device 152 may be, for example, a Joule-Thompson (“J-T”) valve.

The expansion device 152 serves as an expander to obtain additional cooling of the fluid stream 10. Preferably, partial liquefaction of the fluid stream 10 is also created. A Joule-Thompson (or “J-T”) valve is preferred for gas feed streams that are prone to forming solids. The expansion device 152 is preferably mounted close to the cryogenic distillation tower 100 to minimize heat loss in the feed piping and to minimize the chance of plugging with solids in case some components (such as CO₂ or benzene) are dropped below their freezing points.

As an alternative to a J-T valve, the expander device 152 may be a turbo-expander. A turbo-expander provides greater cooling and creates a source of shaft work for processes like the refrigeration unit mentioned above. The heat exchanger 150 is part of the refrigeration unit. In this manner, the operator may minimize the overall energy requirements for the distillation process. However, the turbo-expander may not handle frozen particles as well as the J-T valve.

In either instance, the heat exchanger 150 and the expander device 152 convert the raw gas in the initial fluid stream 10 into a chilled fluid stream 12. Preferably, the temperature of the chilled fluid stream 12 is around −40° to −70° F. In one aspect, the cryogenic distillation tower 100 is operated at a pressure of about 550 psi, and the chilled fluid stream 12 is at approximately −62° F. At these conditions, the chilled fluid stream 12 is in a substantially liquid phase, although some vapor phase may inevitably be entrained into the chilled fluid stream 12. Most likely, no solids formation has arisen from the presence of CO₂.

The CFZ™ cryogenic distillation tower 100 is divided into three primary sections. These are a lower distillation zone, or “stripping section” 106, an intermediate controlled freezing zone, or “spray section” 108, and an upper distillation zone, or “rectification section” 110. In the tower arrangement of FIG. 1, the chilled fluid stream 12 is introduced into the distillation tower 100 in the controlled freezing zone 108. However, the chilled fluid stream 12 may alternatively be introduced near the top of the lower distillation zone 106.

It is noted in the arrangement of FIG. 1 that the lower distillation zone 106, the intermediate spray section 108, the upper distillation zone 110, and the related components are housed within a single vessel 100. However, for offshore applications in which height of the tower 100 and motion considerations may need to be considered, or for remote locations in which transportation limitations are an issue, the tower 110 may optionally be split into two separate pressure vessels (not shown). For example, the lower distillation zone 106 and the controlled freezing zone 108 may be located in one vessel, while the upper distillation zone 108 is in another vessel. External piping would then be used to interconnect the two vessels.

In either embodiment, the temperature of the lower distillation zone 106 is higher than the feed temperature of the chilled fluid stream 12. The temperature of the lower distillation zone 106 is designed to be well above the boiling point of the methane in the chilled fluid stream 12 at the operating pressure of the column 100. In this manner, methane is preferentially stripped from the heavier hydrocarbon and liquid acid gas components. Of course, those of ordinary skill in the art will understand that the liquid within the distillation tower 100 is a mixture, meaning that the liquid will “boil” at some intermediate temperature between pure methane and pure CO₂. Further, in the event that there are heavier hydrocarbons present in the mixture (such as ethane or propane), this will increase the boiling temperature of the mixture. These factors become design considerations for the operating temperatures within the distillation tower 100.

In the lower distillation zone 106, the CO₂ and any other liquid-phase fluids gravitationally fall towards the bottom of the cryogenic distillation tower 100. At the same time, methane and other vapor-phase fluids break out and rise upwards towards the top of the tower 100. This separation is accomplished primarily through the density differential between the gas and liquid phases. However, the separation process is optionally aided by internal components within the distillation tower 100. As described below, these include a melt tray 130, a plurality of advantageously-configured mass transfer devices 126, and an optional heater line 25. Side reboilers (not shown) may likewise be added to the lower distillation zone 106 to facilitate removal of methane, as well as to pre-cool the raw gas feed stream.

Referring again to FIG. 1, the chilled fluid stream 12 may be introduced into the column 100 near the top of the lower distillation zone 106. Alternatively, it may be desirable to introduce the feed stream 12 into the controlled freezing zone 108 above the melt tray 130. The point of injection of the chilled fluid stream 12 is a design issue dictated primarily by the composition of the initial fluid stream 10.

Where the temperature of the chilled fluid stream 12 is high enough (such as greater than −70° F.) such that solids are not expected, it may be preferable to inject the chilled fluid stream 12 directly into the lower distillation zone 106 through a two-phase flashbox type device (or vapor distributor) 124 in the column 100. The use of a flashbox 124 serves to at least partially separate the two-phase vapor-liquid mixture in the chilled fluid stream 12. The flashbox 124 may be slotted such that the two-phase fluid impinges against baffles in the flashbox 124.

If solids are anticipated due to a low inlet temperature, the chilled fluid stream 12 may need to be partially separated in a vessel 173 prior to feeding the column 100 as described above. In this case, the chilled feed stream 12 may be separated in a two phase separator 173 to minimize the possibility of solids plugging the inlet line and internal components of the column 100. Gas vapor leaves the two phase separator 173 through a vessel inlet line 11, where it enters the column 100 through an inlet distributor 121. The gas then travels upward through the column 100. A liquid/solid slurry 13 is discharged from the two phase separator 173. The liquid/solid slurry is directed into the column 100 through the vapor distributor 124 and to the melt tray 130. The liquid/solid slurry 13 can be fed to the column 100 by gravity or by a pump 175.

In either arrangement, that is, with or without the two phase separator 173, the chilled fluid stream 12 (or 11) enters the column 100. The liquid component leaves the flashbox 124 and travels down a collection of stripping trays 126 within the lower distillation zone 106. The stripping trays 126 include a series of weirs 128 and downcomers 129. These are described more fully below in connection with FIG. 3. The stripping trays 126, in combination with the warmer temperature in the lower distillation zone 106, cause methane to break out of solution. The resulting vapor carries the methane and any entrained carbon dioxide molecules that have boiled off.

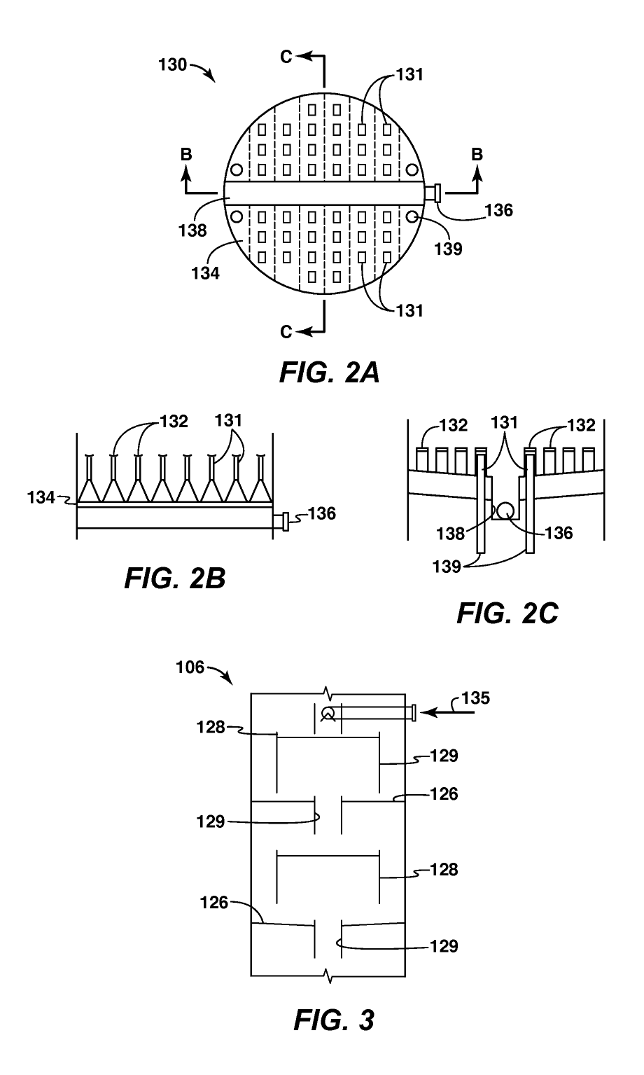

The vapor further proceeds upward through risers or chimneys 131 of the melt tray 130 (seen in FIG. 2B) and into the freeze zone 108. The chimneys 131 act as a vapor distributor for uniform distribution through the freeze zone 108. The vapor will then contact cold liquid from spray headers 120 to “freeze out” the CO₂. Stated another way, CO₂ will freeze and then precipitate or “snow” back onto the melt tray 130. The solid CO₂ then melts and gravitationally flows in liquid form down the melt tray 130 and through the lower distillation zone 106 there below.

As will be discussed more fully below, the spray section 108 is an intermediate freeze zone of the cryogenic distillation tower 100. With the alternate configuration in which the chilled fluid stream 12 is separated in vessel 173 prior to entering the tower 100, a part of the separated liquid/solid slurry 13 is introduced into the tower 100 immediately above the melt tray 130. Thus, a liquid-solid mixture of acid gas and heavier hydrocarbon components will flow from the distributor 121, with solids and liquids falling down onto the melt tray 130.

The melt tray 130 is configured to gravitationally receive liquid and solid materials, primarily CO₂ and H₂S, from the intermediate controlled freezing zone 108. The melt tray 130 serves to warm the liquid and solid materials and direct them downward through the lower distillation zone 106 in liquid form for further purification. The melt tray 130 collects and warms the solid-liquid mixture from the controlled freezing zone 108 in a pool of liquid. The melt tray 130 is designed to release vapor flow back to the controlled freezing zone 108, to provide adequate heat transfer to melt the solid CO₂, and to facilitate liquid/slurry drainage to the lower distillation or lower distillation zone 106 of the column 100 below the melt tray 130.

FIG. 2A provides a plan view of the melt tray 130, in one embodiment. FIG. 2B provides a cross-sectional view of the melt tray 130, taken across line B-B of FIG. 2A. FIG. 2C shows a cross-sectional view of the melt tray 130, taken across line C-C. The melt tray 130 will be described with reference to these three drawings collectively.

First, the melt tray 130 includes a base 134. The base 134 may be a substantially planar body. However, in the preferred embodiment shown in FIGS. 2A, 2B and 2C, the base 134 employs a substantially non-planar profile. The non-planar configuration provides an increased surface area for contacting liquids and solids landing on the melt tray 130 from the controlled freezing zone 108. This serves to increase heat transfer from the vapors passing up from the lower distillation zone 106 of the column 100 to the liquids and thawing solids. In one aspect, the base 134 is corrugated. In another aspect, the base 134 is substantially sinusoidal. This aspect of the tray design is shown in FIG. 2B. It is understood that other non-planar geometries may alternatively be used to increase the heat transfer area of the melt tray 130.

The melt tray base 134 is preferably inclined. The incline is demonstrated in the side view of FIG. 2C. Although most solids should be melted, the incline serves to ensure that any unmelted solids in the liquid mixture drain off of the melt tray 130 and into the distillation zone 106 there below.

In the view of FIG. 2C, a sump or channel 138 is seen central to the melt tray 130. The melt tray base 134 slopes inwardly towards the channel 138 to deliver the solid-liquid mixture. The base 134 may be sloped in any manner to facilitate gravitational liquid draw-off.

As described in U.S. Pat. No. 4,533,372, the melt tray was referred to as a “chimney tray.” This was due to the presence of a single venting chimney. The chimney provided an opening through which vapors may move upward through the chimney tray. However, the presence of a single chimney meant that all gases moving upward through the chimney tray had to egress through the single opening. On the other hand, in the melt tray 130 of FIGS. 2A, 2B and 2C, a plurality of chimneys 131 is provided. The use of multiple chimneys 131 provides improved vapor distribution. This contributes to better heat/mass transfer in the intermediate controlled freezing zone 108.

The chimneys 131 may be of any profile. For instance, the chimneys 131 may be round, rectangular, or any other shape that allows vapor to pass through the melt tray 130. The chimneys 131 may also be narrow and extend upwards into the controlled freezing zone 108. This enables a beneficial pressure drop to distribute the vapor evenly as it rises into the CFZ controlled freezing zone 108. The chimneys 131 are preferably located on peaks of the corrugated base 134 to provide additional heat transfer area.

The top openings of the chimneys 131 are preferably covered with hats or caps 132. This minimizes the chance that solids dropping from the controlled freezing zone 108 can avoid falling onto the melt tray 130. In FIGS. 2A, 2B and 2C, caps 132 are seen above each of the chimneys 131.

The melt tray 130 may also be designed with bubble caps. The bubble caps define convex indentations in the base 134 rising from underneath the melt tray 130. The bubble caps further increase surface area in the melt tray 130 to provide additional heat transfer to the CO₂-rich liquid. With this design, a suitable liquid draw off, such as an increased incline angle, should be provided to insure that liquid is directed to the stripping trays 126 below.

Referring again to FIG. 1, the melt tray 130 may also be designed with an external liquid transfer system. The transfer system serves to ensure that all liquid is substantially free of solids and that sufficient heat transfer has been provided. The transfer system first includes a draw-off nozzle 136. In one embodiment, the draw-off nozzle 136 resides within the draw-off sump, or channel 138 (shown in FIG. 2C). Fluids collected in the channel 138 are delivered to a transfer line 135. Flow through the transfer line 135 may be controlled by a control valve 137 and a level controller “LC” (seen in FIG. 1). Fluids are returned to the lower distillation zone 106 via the transfer line 135. If the liquid level is too high, the control valve 137 opens; if the level is too low, the control valve 137 closes. If the operator chooses not to employ the transfer system in the lower distillation zone 106, then the control valve 137 is closed and fluids are directed immediately to the mass transfer devices, or “stripping trays” 126 below the melt tray 130 for stripping via an overflow downcomer 139.

Whether or not an external transfer system is used, solid CO₂ is warmed on the melt tray 130 and converted to a CO₂-rich liquid. The melt tray 130 is heated from below by vapors from the lower distillation zone 106. Supplemental heat may optionally be added to the melt tray 130 or just above the melt tray base 134 by various means such as heater line 25. The heater line 25 utilizes thermal energy already available from a bottom reboiler 160 to facilitate thawing of the solids.

The CO₂-rich liquid is drawn off from the melt tray 130 under liquid level control and gravitationally introduced to the lower distillation zone 106. As noted, a plurality of stripping trays 126 are provided in the lower distillation zone 106 below the melt tray 130. The stripping trays 126 are preferably in a substantially parallel relation, one above the other. Each of the stripping trays 126 may optionally be positioned at a very slight incline, with a weir such that a liquid level is maintained on the tray. Fluids gravitationally flow along each tray, over the weir, and then flow down onto the next tray via a downcomer.

The stripping trays 126 may be in a variety of arrangements. The stripping trays 126 may be arranged in generally horizontal relation to form a back-and-forth, cascading liquid flow. However, it is preferred that the stripping trays 126 be arranged to create a cascading liquid flow that is divided by separate stripping trays substantially along the same horizontal plane. This is shown in the arrangement of FIG. 3, where the liquid flow is split at least once so that liquid flows across separate trays and falls into two opposing downcomers 129.

FIG. 3 provides a side view of a stripping tray 126 arrangement, in one embodiment. Each of the stripping trays 126 receives and collects fluids from above. Each stripping tray 126 preferably has a weir 128 that serves as a dam to enable the collection of a small pool of fluid on each of the stripping trays 126. The buildup may be ½ to 1 inch, though any height may be employed. A waterfall effect is created by the weirs 128 as fluid falls from one tray 126 on to a next lower tray 126. In one aspect, no incline is provided to the stripping trays 126, but the waterfall effect is created through a higher weir 128 configuration. The fluid is contacted with upcoming vapor rich in lighter hydrocarbons that strip out the methane from the cross flowing liquid in this “contact area” of the trays 126. The weirs 128 serve to dynamically seal the downcomers 129 to help prevent vapor from bypassing through the downcomers 129 and to further facilitate the breakout of hydrocarbon gases.

The percentage of methane in the liquid becomes increasingly small as the liquid moves downward through the lower distillation zone 106. The extent of distillation depends on the number of trays 126 in the lower distillation zone 106. In the upper part of the lower distillation zone 106, the methane content of the liquid may be as high as 25 mol percent, while at the bottom stripping tray the methane content may be as low as 0.04 mol percent. The methane content flashes out quickly along the stripping trays 126 (or other mass transfer devices). The number of mass transfer devices used in the lower distillation zone 106 is a matter of design choice based on the composition of the raw gas stream 10, the tower pressure, and methane specification of the bottoms stream 26. However, only a few levels of stripping trays 126 need be typically utilized to remove methane to a desired level of 1% or less in the liquefied acid gas, for example.

Various individual stripping tray 126 configurations that facilitate methane breakout may be employed. The stripping tray 126 may simply represent a panel with sieve holes or bubble caps. However, to provide further heat transfer to the fluid and to prevent unwanted blockage due to solids, so called “jet trays” may be employed below the melt tray. In lieu of trays, random or structured packing may also be employed.

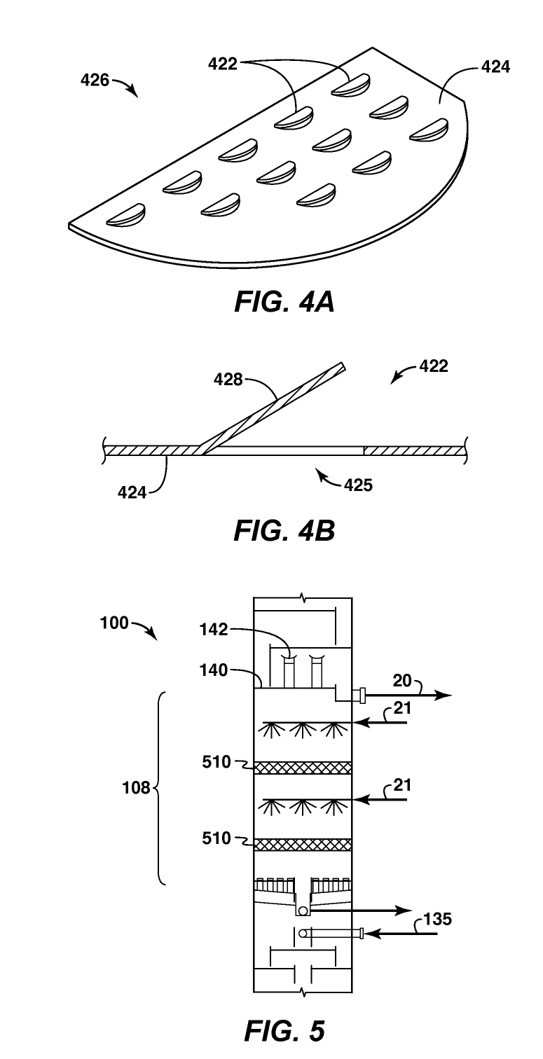

FIG. 4A provides a plan view of an illustrative jet tray 426, in one embodiment. FIG. 4B provides a cross-sectional view of a jet tab 422 from the jet tray 426. As shown, each jet tray 426 has a body 424, with a plurality of jet tabs 422 formed within the body 424. Each jet tab 422 includes an inclined tab member 428 covering an opening 425. Thus, a jet tray 426 has a plurality of small openings 425.

In operation, one or more jet trays 426 may be located in the lower distillation zone 106 and/or the upper distillation zone 110 of the tower 100. The trays 426 may be arranged with multiple passes such as the pattern of stripping trays 126 in FIG. 3. However, any tray or packing arrangement may be utilized that facilitates the breakout of methane gas. Fluid cascades down upon each jet tray 426. The fluids then flow along the body 424. The tabs 422 are optimally oriented to move the fluid quickly and efficiently across the tray 426. An adjoined downcomer (not shown) may optionally be provided to move the liquid to the subsequent tray 426. The openings 425 also permit gas vapors released during the fluid movement process in the lower distillation zone 106 to travel upwards more efficiently to the melt tray 130 and through the chimneys 131.

In one aspect, the trays (such as trays 126 or 426) may be fabricated from fouling-resistant materials, that is, materials that prevent solids-buildup. Fouling-resistant materials are utilized in some processing equipment to prevent the buildup of corrosive metal particles, polymers, salts, hydrates, catalyst fines, or other chemical solids compounds. In the case of the cryogenic distillation tower 100, fouling resistant materials may be used in the trays 126 or 426 to limit sticking of CO₂ solids. For example, a Teflon™ coating may be applied to the surface of the trays 126 or 426.

Alternatively, a physical design may be provided to ensure that the CO₂ does not start to build up in solid form along the inner diameter of the column 100. In this respect, the jet tabs 422 may be oriented to push liquid along the wall of the column 100, thereby preventing solids accumulation along the wall of the column 100 and ensuring good vapor-liquid contact.

In any of the tray arrangements, as the down-flowing liquid hits the stripping trays 126, separation of materials occurs. Methane gas breaks out of solution and moves upward in vapor form. The CO₂, however, is generally cold enough and in high enough concentration that it mostly remains in its liquid form and travels down to the bottom of the lower distillation zone 106, though some CO₂ will inevitably be vaporized in the process. The liquid is then moved out of the cryogenic distillation tower 100 in an exit line as a bottoms fluid stream 22.

Upon exiting the distillation tower 100, the bottoms fluid stream 22 enters a reboiler 160. In FIG. 1, the reboiler 160 is a kettle-type vessel that provides reboiled vapor to the bottom of the stripping trays. A reboiled vapor line is seen at 27. In addition, reboiled vapor may be delivered through a heater line 25 to provide supplemental heat to the melt tray 130. The supplemental heat is controlled through a valve 165 and temperature controller TC. Alternatively, a heat exchanger, such as a thermosyphon heat exchanger (not shown) may be used to cool the initial fluid stream 10 to economize energy. In this respect, the liquids entering the reboiler 160 remain at a relatively low temperature, for example, about 30° to 40° F. By heat integrating with the initial fluid stream 10, the operator may warm and partially boil the cool bottoms fluid stream 22 from the distillation tower 100 while pre-cooling the production fluid stream 10. For this case, the fluid providing supplemental heat through line 25 is a mixed phase return from the reboiler 160.

It is contemplated that under some conditions, the melt tray 130 may operate without heater line 25. In these instances, the melt tray 130 may be designed with an internal heating feature such as an electric heater. However, it is preferred that a heat system be offered that employs the heat energy available in the bottoms fluid stream 22. The warm fluids in heater line 25 exist in one aspect at 30° to 40° F., so they contain relative heat energy. Thus, in FIG. 1, a warm vapor stream in heater line 25 is shown being directed to the melt tray 130 through a heating coil (not shown) on the melt tray 130. The warm vapor stream may alternatively be tied to the transfer line 135.

In operation, most of the reboiled vapor stream is introduced at the bottom of the column through line 27, above the bottom liquid level and at or below the last stripping tray 126. As the reboiled vapor passes upward through each tray 126, residual methane is stripped out of the liquid. This vapor cools off as it travels up the tower. By the time the vapor stream from line 27 reaches the corrugated melt tray 130, the temperature may drop to about −20° F. to 0° F. However, this remains quite warm compared to the melting solid on the melt tray 130, which may be around −50° F. to −70° F. The vapor still has enough enthalpy to melt the solid CO₂ as it comes in contact with the melt tray 130.

Referring back to reboiler 160, fluids in a bottom stream 24 that exit the reboiler 160 in liquid form may optionally pass through an expander valve 162. The expander valve 162 reduces the pressure of the bottom liquid product, effectively providing a refrigeration effect. Thus, a chilled bottom stream 26 is provided. The CO₂-rich liquid exiting the reboiler 160 may be pumped downhole through one or more AGI wells (seen schematically at 250 in FIG. 1). In some situations, the liquid CO₂ may be pumped into a partially recovered oil reservoir as part of an enhanced oil recovery process. Thus, the CO₂ could be a miscible injectant. As an alternative, the CO₂ may be used as a miscible flood agent for enhanced oil recovery.

Referring again to the lower distillation zone 106 of the tower 100, gas moves up through the lower distillation zone 106, through the chimneys 131 in the melt tray 130, and into the controlled freezing zone 108. The controlled freezing zone 108 defines an open chamber having a plurality of spray nozzles 122. As the vapor moves upward through the controlled freezing zone 108, the temperature of the vapor becomes much colder. The vapor is contacted by liquid methane (“reflux”) coming from the spray nozzles 122. This liquid methane is much colder than the upwardly-moving vapor, having been chilled by an external refrigeration unit that includes a heat exchanger 170. In one arrangement, the liquid methane exists from spray nozzles 122 at a temperature of approximately −120° F. to −130° F. However, as the liquid methane evaporates, it absorbs heat from its surroundings, thereby reducing the temperature of the upwardly-moving vapor. The vaporized methane also flows upward due to its reduced density (relative to liquid methane) and the pressure gradient within the distillation tower 100.

As the methane vapors move further up the cryogenic distillation tower 100, they leave the intermediate controlled freezing zone 108 and enter the upper distillation zone 110. The vapors continue to move upward along with other light gases broken out from the original chilled fluid stream 12. The combined hydrocarbon vapors move out of the top of the cryogenic distillation tower 100, becoming an overhead methane stream 14.

The hydrocarbon gas in overhead methane stream 14 is moved into the external refrigeration unit 170. In one aspect, the refrigeration unit 170 uses an ethylene refrigerant or other refrigerant capable of chilling the overhead methane stream 14 down to about −135° to −145° F. This serves to at least partially liquefy the overhead methane stream 14. The refrigerated methane stream 14 is then moved to a reflux condenser or separation chamber 172.

The separation chamber 172 is used to separate gas 16 from liquid, referred to sometimes as “liquid reflux” 18. The gas 16 represents the lighter hydrocarbon gases, primarily methane, from the original raw gas stream 10. Nitrogen and helium may also be present. The methane gas 16 is, of course, the “product” ultimately sought to be captured and sold commercially, along with any traces of ethane. This non-liquefied portion of the overhead methane stream 14 is also available for fuel on-site.

A portion of the overhead methane stream 14 exiting the refrigeration unit 170 is condensed. This portion is the liquid reflux 18 that is separated in the separation chamber 172 and returned to the tower 100. A pump 19 may be used to move the liquid reflux 18 back into the tower 100. Alternatively, the separation chamber 172 is mounted above the tower 100 to provide a gravity feed of the liquid reflux 18. The liquid reflux 18 will include any carbon dioxide that escaped from the upper distillation zone 110. However, most of the liquid reflux 18 is methane, typically 95% or more, with nitrogen (if present in the initial fluid stream 10) and traces of hydrogen sulfide (also if present in the initial fluid stream 10).

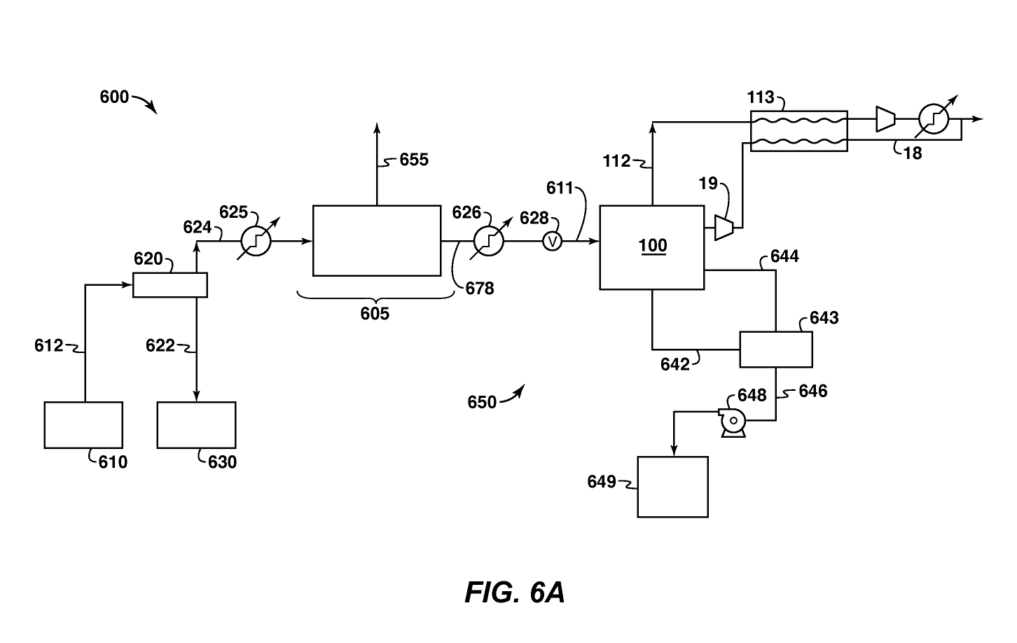

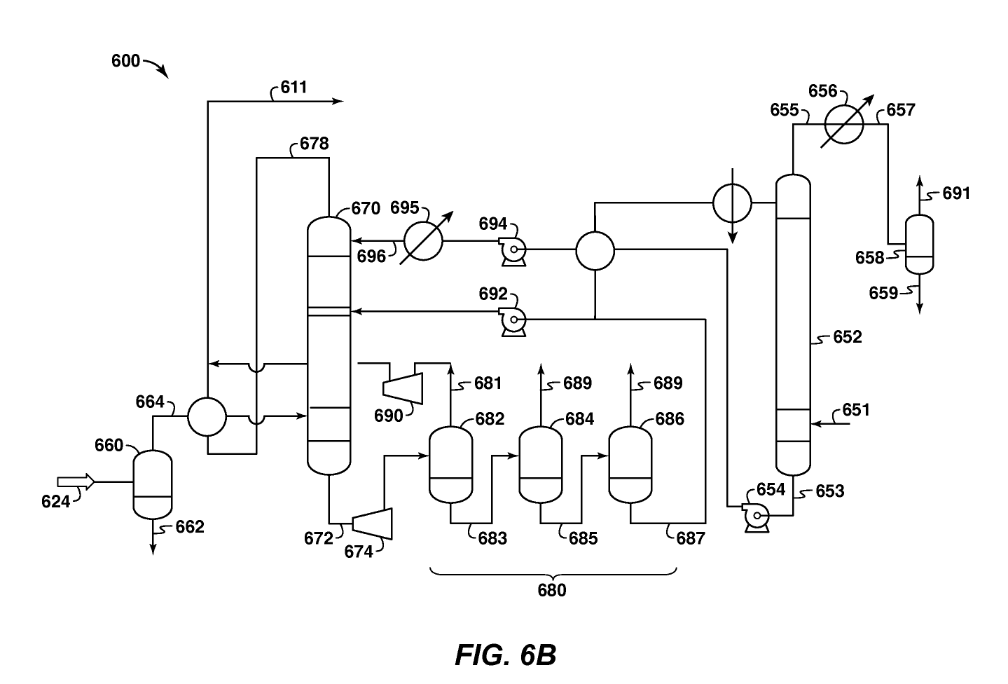

In one cooling arrangement, the overhead methane stream 14 is taken through an open-loop refrigeration system, such as the refrigeration system shown in and described in connection with FIG. 6A. In this arrangement of FIG. 6A, the overhead methane stream 112 is taken through a cross-exchanger 113 to chill a return portion of the overhead methane stream used as the liquid reflux 18. Thereafter, the overhead methane stream 112 is pressurized to about 1,000 psi to 1,400 psi, and then cooled using ambient air and possibly an external propane refrigerant. The pressurized and chilled gas stream is then directed through an expander for further cooling. A turbo expander may be used to recover even more liquid as well as some shaft work. U.S. Pat. No. 6,053,007 entitled “Process For Separating a Multi-Component Gas Stream Containing at Least One Freezable Component,” describes the cooling of an overhead methane stream, and is incorporated herein in its entirety by reference.

It is understood here that the present inventions are not limited by the cooling method for the overhead methane stream 14. It is also understood that the degree of cooling between refrigeration unit 170 and the initial refrigeration unit 150 may be varied. In some instances, it may be desirable to operate the refrigeration unit 150 at a higher temperature, but then be more aggressive with cooling the overhead methane stream 14 in the refrigeration unit 170. Again, the present inventions are not limited to these types of design choices.

Returning again to FIG. 1, the liquid reflux 18 is returned into the upper distillation zone 110. The liquid reflux 18 is then gravitationally carried through one or more mass transfer devices 116 in the upper distillation zone 110. In one embodiment, the mass transfer devices 116 are rectification trays that provide a cascading series of weirs 118 and downcomers 119, similar to trays 126 described above.

As fluids from the liquid reflux stream 18 move downward through the rectification trays 116, additional methane vaporizes out of the upper distillation zone 110. The methane gases rejoin the overhead methane stream 14 to become part of the gas product stream 16. However, the remaining liquid phase of the liquid reflux 18 falls onto a collector tray 140. As it does so, the liquid reflux stream 18 unavoidably will pick up a small percentage of hydrocarbon and residual acid gases moving upward from the controlled freezing zone 108. The liquid mixture of methane and carbon dioxide is collected at a collector tray 140.

The collector tray 140 preferably defines a substantially planar body for collecting liquids. However, as with melt tray 130, collector tray 140 also has one, and preferably a plurality of chimneys for venting gases coming up from the controlled freezing zone 108. A chimney and cap arrangement such as that presented by components 131 and 132 in FIGS. 2B and 2C may be used. Chimneys 141 and caps 142 for collector tray 140 are shown in the enlarged view of FIG. 5, discussed further below.

It is noted here that in the upper distillation zone 110, any H₂S present has a preference towards being dissolved in the liquid versus being in the gas at the processing temperature. In this respect, the H₂S has a comparatively low relative volatility. By contacting the remaining vapor with more liquid, the cryogenic distillation tower 100 drives the H₂S concentration down to within the desired parts-per-million (ppm) limit, such as a 10 or even a 4 ppm specification. As fluid moves through the mass transfer devices 116 in the upper distillation zone 110, the H₂S contacts the liquid methane and is pulled out of the vapor phase and becomes a part of the liquid stream 20. From there, the H₂S moves in liquid form downward through the lower distillation zone 106 and ultimately exits the cryogenic distillation tower 100 as part of the liquefied acid gas bottoms stream 22.

In cryogenic distillation tower 100, the liquid captured at collector tray 140 is drawn out of the upper distillation zone 110 as a liquid stream 20. The liquid stream 20 is comprised primarily of methane. In one aspect, the liquid stream 20 is comprised of about 93 mol. percent methane, 3% CO₂, 0.5% H₂S, and 3.5% N₂, At this point, the liquid stream 20 is at about −125° F. to −130° F. This is only slightly warmer than the liquid reflux stream 18. The liquid stream 20 is directed into a reflux drum 174. The purpose of the reflux drum 174 is to provide surge capacity for a pump 176. Upon exiting the reflux drum 174, a spray stream 21 is created. Spray stream 21 is pressurized in a pump 176 for a second reintroduction into the cryogenic distillation tower 100. In this instance, the spray stream 21 is pumped into the intermediate controlled freezing zone 108 and emitted through nozzles 122.

Some portion of the spray stream 21, particularly the methane, vaporizes and evaporates upon exiting the nozzles 122. From there, the methane rises through the controlled freezing zone 108, through the chimneys in the collector tray 140, and through the mass transfer devices 116 in the upper distillation zone 110. The methane leaves the distillation tower 100 as the overhead methane stream 14 and ultimately becomes part of the commercial product in gas stream 16.

The spray stream 21 from the nozzles 122 also causes carbon dioxide to desublime from the gas phase. In this respect, CO₂ initially dissolved in the liquid methane may momentarily enter the gas phase and move upward with the methane. However, because of the cold temperature within the controlled freezing zone 108, any gaseous carbon dioxide quickly nucleates and agglomerates into a solid phase and begins to “snow.” This phenomenon is referred to as desublimation. In this way, some CO₂ never re-enters the liquid phase until it hits the melt tray 130. This carbon dioxide “snows” upon the melt tray 130, and melts into the liquid phase. From there, the CO₂-rich liquid cascades down the mass transfer devices or trays 126 in the lower distillation zone 106, along with liquid CO₂ from the chilled raw gas stream 12 as described above. At that point, any remaining methane from the spray stream 21 of the nozzles 122 should quickly break out into vapor. These vapors move upwards in the cryogenic distillation tower 100 and re-enter the upper distillation zone 110.

It is desirable to have chilled liquid contacting as much of the gas that is moving up the tower 100 as possible. If vapor bypasses the spray stream 21 emanating from the nozzles 122, higher levels of CO₂ could reach the upper distillation zone 110 of the tower 100. To improve the efficiency of gas/liquid contact in the controlled freezing zone 108, a plurality of nozzles 122 having a designed configuration may be employed. Thus, rather than employing a single spray source at one or more levels with the reflux fluid stream 21, several spray headers 120 optionally designed with multiple spray nozzles 122 may be used. Thus, the configuration of the spray nozzles 122 has an impact on the heat and mass transfer taking place within the controlled freezing zone 108.

The assignee herein has previously proposed various nozzle arrangements in co-pending WO Pat. Publ. No. 2008/091316 having an international filing date of Nov. 20, 2007. That application and FIGS. 6A and 6B are incorporated herein by reference for teachings of the nozzle configurations. The nozzles seek to ensure 360° coverage within the controlled freezing zone 108 and provide good vapor-liquid contact and heat/mass transfer. This, in turn, more effectively chills any gaseous carbon dioxide moving upward through the cryogenic distillation tower 100.

The use of multiple headers 120 and a corresponding overlapping nozzle 122 arrangement for complete coverage minimizes back-mixing as well. In this respect, complete coverage prevents the fine, low-mass CO₂ particles from moving back up the distillation tower 100 and re-entering the upper distillation zone 110. These particles would then remix with methane and re-enter the overhead methane stream 14, only to be recycled again.

It can be seen that the process of cycling vapors through the cryogenic distillation tower 100 ultimately produces a hydrocarbon product comprised of a commercial methane product 16. The gas product 16 is sent down a pipeline for sale. The gas product stream 16 preferably meets a pipeline CO₂ specification of 1 to 4 mol. percent, as well as a 4 ppm H₂S specification, if sufficient reflux is generated. At the same time, acid gases are removed through exit fluid stream 22.

Should nitrogen be present in quantities of, for example, greater than 3 mol. percent, a separate nitrogen rejection process may be used. Pipeline specifications generally require a total inert gas composition of less than 3 mol. percent. One option for removing excessive nitrogen is to use a solid adsorbent bed (not shown). The solid adsorbent in the bed may be a zeolite material that forms a molecular sieve of having a particular pore size. The molecular sieve is placed along the overhead methane stream to remove nitrogen from the overhead stream. Preferably, this occurs prior to chilling.

Once the molecular sieve is fully adsorbed with nitrogen, it may be regenerated using either pressure swing adsorption or thermal swing adsorption. The molecular sieve generally cannot be regenerated using water adsorption of the raw feed gas, for example, as the desorbed nitrogen will end up back in the column and, thus, is not eliminated from the system.

While the above system described in connection with FIG. 1 is profitable for producing a substantially acid-gas free pipeline gas product 16, the system has the potential of losing heavier hydrocarbons into the chilled bottom stream 26. In this respect, heavier hydrocarbons such as ethane and propane may be present in the initial fluid stream 10. The distillation tower 100 will release lighter components such as methane, helium, nitrogen, and, perhaps, some ethane in the overhead stream 14, but most ethane and other heavier hydrocarbons will be liquefied with the carbon dioxide and, thus, “lost” in the bottom stream 26. These heavier hydrocarbons, of course, have value as a commercial product. Therefore, systems and methods are proposed herein for capturing the heavier hydrocarbons that are produced with the initial fluid stream 10.

The majority of the market supply of C₂ and C₃₊ hydrocarbons are extracted from natural gas. Such components are commonly termed natural gas liquids (NGL's). In one general approach, the heavier hydrocarbons are captured before the initial fluid stream 10 enters the distillation tower 100. In this way a “leaner” gas is fed into the distillation tower 100.

One method for removing heavy hydrocarbons upstream employs the use of physical solvents. Certain physical solvents have an affinity for heavy hydrocarbons and can be used to separate heavy hydrocarbons from methane. Examples of suitable physical solvents include N-methyl pyrollidone, propylene carbonate, methyl cyanoacetate, and refrigerated methanol.

A preferred example of a physical solvent is sulfolane, having a chemical name of tetramethylene sulfone. Sulfolane is an organosulfur compound containing a sulfonyl functional group. The sulfonyl group is a sulfur atom doubly bonded to two oxygen atoms. The sulfur-oxygen double bond is highly polar, allowing for high solubility in water. At the same time, the four-carbon ring provides affinity for hydrocarbons. These properties allow sulfolane to be miscible in both water and hydrocarbons, resulting in its widespread use as a solvent for purifying hydrocarbon mixtures.

Another suitable physical solvent is Selexol™. Selexol™ is a trade name for a gas treating product of Dow Chemical Company. Selexol™ is a mixture of dimethyl ethers of polyethylene glycols. An example of one such component is dimethoxy tetraethylene glycol. Selexol™ may also be used as a solvent for purifying hydrocarbon mixtures.

FIG. 6A is a schematic diagram showing a gas processing facility 600 for removing acid gases from a gas stream, in one embodiment. The gas processing facility employs a physical solvent process upstream of an acid gas removal system. The overall acid gas removal system is indicated generally by 650, while the physical solvent process is indicated by the Block 605. The acid gas removal system 650 includes a separation vessel at Block 100. Block 100 is indicative generally of the controlled freeze zone tower 100 of FIG. 1, but may represent any cryogenic distillation tower.

In FIG. 6A, a production gas stream is shown at 612. The production gas stream 612 originates from hydrocarbon production activities that take place in a reservoir development area, or “field” 610. It is understood that the field 610 may represent any location where gaseous hydrocarbons are produced.

The field 610 may be onshore, near shore or offshore. The field 610 may be operating from original reservoir pressure or may be undergoing enhanced recovery procedures. The systems and methods claimed herein are not limited to the type of field that is under development so long as it is producing hydrocarbons contaminated with acid gas. The hydrocarbons will comprise primarily methane, but will also include 2 to 10 mol. percent ethane and/or other heavier hydrocarbons.

The production gas stream 612 may be passed through a pipeline, for example, from the field 610 to the gas processing facility 600. Upon arrival at the gas processing facility 600, the production gas stream 612 may be directed through a dehydration process such as a glycol dehydration vessel. A dehydration vessel is shown schematically at 620. As a result of passing the production gas stream 612 through the dehydration vessel 620, an aqueous stream 622 is generated. In some cases, the raw gas stream may be mixed with monoethylene glycol (MEG) in order to prevent water drop-out and hydrate formation. The MEG may be sprayed on a chiller, for example, and the liquids collected for separation into water, more concentrated MEG, and possibly some heavy hydrocarbons, depending on the temperature of the chiller and the inlet gas composition.

The aqueous stream 622 may be sent to a water treatment facility. Alternatively, the aqueous stream 622 may be re-injected into a subsurface formation. A subsurface formation is indicated at block 630. Alternatively still, the removed aqueous stream 622 may be treated and then released into the local watershed (not shown) as treated water.

Also, as a result of passing the production gas stream 612 through the dehydration vessel 620, a substantially dehydrated raw gas stream 624 is produced. The raw gas stream 624 may contain trace amounts of nitrogen, helium and other inert gases. In connection with the present systems and methods, the dehydrated gas stream 624 also contains ethane and, perhaps, propane or even trace amounts of butane and aromatic hydrocarbons. These represent heavy hydrocarbons.

The raw gas stream 624 is optionally passed through a preliminary refrigeration unit 625. The refrigeration unit 625 chills the gas stream 624 down to a temperature of about 20° F. to 50° F. The refrigeration unit 625 may be, for example, an air cooler or an ethylene or a propane refrigerator.

In the systems illustrated in FIG. 6A, the systems remove the heavier hydrocarbons from the raw gas stream 624. In accordance with the gas processing facility 600, a physical solvent system 605 is provided. The dehydrated gas stream 624 enters the physical solvent system 605. The physical solvent system 605 contacts the gas stream 624 with a physical solvent to remove heavy hydrocarbons through a process of absorption. This takes place at relatively low temperatures and relatively high pressures wherein the solubility of the acid gas components is greater than that of methane.

FIG. 6B provides a schematic diagram of a physical solvent system 605, in one embodiment. The physical solvent system 605 operates to contact the dehydrated gas stream 624 in order to remove heavy hydrocarbons. The dehydrated gas stream 624 can be seen entering an inlet separator 660. The inlet separator 660 serves to remove any condensed hydrocarbons. The inlet separator 660 may also filter out liquid impurities such as drilling fluids. Ideally, water is removed in the upstream dehydration vessel 620. Some particle filtration may also take place. It is understood that it is desirable to keep the gas stream 624 clean so as to prevent foaming of liquid solvent during the acid gas treatment process.

Liquids such as drilling fluids drop out of the bottom of the inlet separator 660. A liquid impurities stream is seen at 662. The liquid impurities are typically sent to a water treatment facility (not shown), or may be reinjected into the formation to sustain reservoir pressure or for disposal. Gas exits from the top of the inlet separator 660. A cleaned gas stream is seen at 664.

The cleaned gas stream 664 is optionally directed into a gas-to-gas exchanger 665. The gas-to-gas exchanger 665 pre-cools the gas in the cleaned gas stream 664. The cleaned gas is then directed to an absorber 670. The absorbent in the absorber 670 may be, for example, a solvent, while the absorber 670 may be a counter-current contacting tower. In this respect, the cleaned gas stream 664 enters at the bottom of the tower 670 while the solvent 696 enters at the top of the tower 670. The tower 670 may be a trayed tower, a packed tower, or other type of tower.

It is understood that any number of non-tower devices designed for gas-liquid contact may alternatively be utilized. These may include static mixers and co-current contacting devices. The counter-current tower of FIG. 6B is merely for illustrative purposes. Of note, the use of compact, co-current contactors for the gas-liquid contacting vessel(s) is preferred as such can reduce the overall footprint and weight of the physical solvent system 605.

As a result of the contacting process, a light gas stream 678 is generated. The light gas stream 678 comes out of the top of the tower 670. The light gas stream 678 then goes through a refrigeration process before being directed to the cryogenic distillation tower, shown schematically at Block 100 in FIG. 6A.

Referring momentarily back to FIG. 6A, the light gas stream 678 exits the physical solvent system 605 and passes through a chiller 626. The chiller 626 chills the light gas stream 678 down to a temperature of about −30° F. to −40° F. The chiller 626 may be, for example, an ethylene or a propane refrigerator.

The light gas stream 678 is next preferably moved through an expansion device 628. The expansion device 628 may be, for example, a Joule-Thompson (“J-T”) valve. The expansion device 628 serves as an expander to obtain further cooling of the light gas stream 678. The expansion device 628 further reduces the temperature of the light gas stream 678 down to, for example, about −70° F. to −80° F. Preferably, at least partial liquefaction of the gas stream 624 is also accomplished. The cooled gas stream is indicated at line 611.

Referring again to FIG. 6B, the contacting tower 670 will pick up heavy hydrocarbons. These are released from the bottom of the tower 670 as a “rich” solvent. A rich solvent stream 672 is seen exiting the tower 670.

In the arrangement of FIG. 6B, the rich solvent stream 672 is carried through a power recovery turbine 674. This allows electrical energy to be generated for the physical solvent system 605. From there, the rich solvent stream 672 is carried through a series of flash separators 680. In the illustrative arrangement of FIG. 6B, three separators are shown at 682, 684 and 686. The separators 682, 684, 686 operate at progressively lower temperatures and pressures in accordance with the physical solvent process.

The first separator 682 may operate, for example, at a pressure of 500 psi and a temperature of 90° F. The first separator 682 releases light gases entrained in the rich solvent stream 672. These light gases, shown at 681, comprise primarily methane, CO₂, and any H₂S. The light gases 681 are directed to the cryogenic distillation tower 100 as part of the light gas stream 678. The light gases 681 preferably travel through a compressor 690 to boost pressure en route to the cryogenic distillation tower 100. Compression may not be necessary if the distillation tower 100 is operated at a lower pressure than the first flash stage 682 of the solvent process.

Ideally, all heavy hydrocarbons from the cleaned gas stream 664 have been captured with the rich solvent stream 672. A progressively richer solvent stream is released from each separator 682, 684, 686. These progressively rich streams are denoted at lines 683, 685 and 687. Thus, the physical solvent is generally regenerated by pressure reduction causing the dissolved gases to flash from the solvent.

Line 687 is, of course, the richest solvent stream. A portion of this solvent stream 687 is carried through a booster pump 692 and reintroduced into the contacting tower 670 as a semi-lean solvent. The remaining portion, shown at 693, is directed into a stripping vessel 652.

In connection with the second 684 and third 686 of the three separators, it is noted that each of these separators 684, 686 also releases very small amounts of light gases. These light gases will primarily include carbon dioxide with possibly small amounts of methane. These light gases are shown in two separate lines at 689. The light gases 689 may be compressed and combined with line 611 and then be directed into the cryogenic distillation tower 100. Alternatively, the light gases from lines 689 may be delivered directly to a bottom liquefied acid gas stream shown at 642 in FIG. 6A.

One advantage of using a physical solvent for upstream heavy hydrocarbon removal is that the solvent is generally hygroscopic. This may eliminate the need for a subsequent gas dehydration step. To this end, it is preferable that the selected solvent be dry. In this way, the solvent may be used to further dehydrate the raw natural gas. In this case, water may come out in vapor stream 691 from the regenerator 652. A disadvantage is that some light hydrocarbons and CO₂ will be co-adsorbed in the physical solvent to some extent. The use of multiple separators 682, 684, 686 does remove most of the methane, but typically not all of it.

Referring again to the stripping vessel 652, the stripping vessel 652 acts as a heater. Heavy hydrocarbons are driven off so that they exit the stripping vessel 652 through line 655. The heavy hydrocarbons 655 are shown exiting the physical solvent system 605 in both FIGS. 6A and 6B. The heavy hydrocarbons 655 may be directed through a heat exchanger 656 for cooling. There, the heavy hydrocarbons 655 are condensed and a liquid heavy hydrocarbon product is created at 657. The liquid heavy hydrocarbon product 657 comprises natural gas liquids, or NGL's. The NGL's 657 may optionally be sent through a final separating vessel 658. The separating vessel 658 releases the small amount of remaining methane, CO₂, water vapor, and stripping gas (shown at 651 and discussed below) from the top of the vessel 658 through line 691, while purified natural gas liquids are captured as commercial product for resale near the bottom of the vessel 658 through line 659.

The stripping vessel 652 depicted in FIG. 6B utilizes a stripping gas to separate heavy hydrocarbons from solvent. The stripping vessel 652 can be fed with any number of stripping gases. An example is a fuel gas stream with a high-CO₂ content. A high-CO₂ content is preferred for the stripping gas 651 as it may help “pre-saturate” the solvent with CO₂, thereby leading to less CO₂ pickup from the raw gas 624. The stripping gas 651 may be, for example a portion of the light gas stream 689 from the lowest-pressure flash stage, that is, separator 686, allowing potential recovery of some of the hydrocarbons. In any case, once the heavy hydrocarbons are evaporated out of the stripping vessel 652, the stripping gas 651 may be recycled to the stripping vessel 652 via a compressor or blower (not shown).

Regenerated solvent is directed from the bottom of the regeneration vessel 652. The regenerated solvent exits as 653. The regenerated solvent 653 is carried through a small booster pump 654. A subsequent larger pump 694 may be utilized to reach a higher operating pressure for the top of the column 670. Thereafter, the regenerated solvent 653 is preferably cooled through a heat exchanger 695 having a refrigeration unit. A chilled and regenerated solvent 696 is then recycled back into the contactor 670.

Referring again to FIG. 6A, the chilled gas stream in line 611 enters the cryogenic distillation tower 100. The cryogenic distillation tower 100 may be any tower that operates to distill methane from acid gases through a process that intentionally freezes CO₂ particles. The cryogenic distillation tower may be, for example, the CFZ™ tower 100 of FIG. 1. The chilled gas stream of line 611 enters the tower 100 at about 500 to 600 psig.

As explained in connection with FIG. 1, acid gases are removed from the distillation tower 100 as a liquefied acid gas bottoms stream 642. The bottoms stream 642 may optionally be sent through a reboiler 643 where fluid containing methane is redirected back into the tower 100 as a gas stream 644. The remaining fluid comprised primarily of acid gases is released through acid gas line 646. The acid gas in line 646 is in liquid form. The acid gas may be vaporized, depressured, and then sent to a sulfur recovery unit (not shown). Alternatively, the liquefied acid gas in line 646 may be injected into a subsurface formation through one or more acid gas injection (AGI) wells as indicated by block 649. In this instance, the acid gas in line 646 is preferably passed through a pressure booster 648.

Methane is released from the distillation tower 100 as an overhead methane stream 112. The overhead methane stream 112 will preferably comprise no more than about 2 mol. percent carbon dioxide. At this percentage, the overhead methane stream 112 may be used as fuel gas or may be sold into certain markets as natural gas. However, in accordance with certain methods herein, it is desirable that the overhead methane stream 112 undergo further processing. More specifically, the overhead methane stream 112 is passed through an open loop refrigeration system.

First, the overhead methane stream 112 is passed through a cross exchanger 113. The cross exchanger 113 serves to pre-cool the reflux stream 18 that is reintroduced into the cryogenic distillation tower 100 after expansion through an expander device 19. The overhead methane stream 112 is next sent through a compressor 114 to increase its pressure.

Next, the pressurized methane stream 112 is cooled. This may be done by, for example, passing the methane stream 112 through an aerial cooler 115. A cool and pressurized methane stream 16 is produced. The methane stream 16 may be liquefied to generate a commercial product.

A part of the cooled and pressurized methane stream 116 leaving the cooler 115 is split into the reflux stream 18. The reflux stream 18 is further cooled in the heat exchanger 113, then expanded through device 19 to generate the cold spray stream 21 of FIG. 1. The cold spray stream 21 enters the distillation tower 100 where it is used as a cold liquid spray. The liquid spray, or reflux, reduces the temperature of the controlled freezing zone (shown at 108 of FIG. 1) and helps to freeze out CO₂ and other acid gas particles from the dehydrated gas stream 624 as described above.

It is finally noted in connection with FIGS. 6A and 6B that if hydrogen sulfide is present in the dehydrated raw gas stream 624, much of it will pass through the separators 682, 684, 686 with the heavy hydrocarbons. Some of the hydrogen sulfide could be cycled back into the contacting tower 670 through line 687. To avoid this scenario, it may be preferable to have an H₂S-selective removal process upstream of the contacting tower 670. The separation can be achieved with traditional H₂5 separation processes such as absorption by selective amines, redox processes, or adsorption. The hydrogen sulfide may be delivered to a sulfur recovery unit (not shown) or into an acid gas injection well 649 and then into a reservoir.

Another potential method for removing heavy hydrocarbons upstream of an acid gas removal system is known as a “lean oil” process. The lean oil process is quite similar to the physical solvent process discussed above. In this case, instead of using a physical solvent in a gas-to-liquid adsorption process, a stream of liquid hydrocarbon is contacted with the cleaned gas stream 664 in a contacting device. Thus, instead of using Sulfolane or Selexol gas as a physical solvent, propane or similar heavy hydrocarbon compound is used.

In the lean oil process, heavy hydrocarbons are preferentially removed from the cleaned gas stream 664 based on the principle “like dissolves like.” The lean oil adsorbs C₃₊ components into what was referred to in FIG. 6B as the rich solvent stream 672. The heavy hydrocarbon components are stripped from the cleaned gas stream 664 in the contacting tower 670. The heavy hydrocarbons in the rich solvent stream 672 may be taken through a separator (such as separator 682) to recover residual methane. A portion of the lean oil/heavy hydrocarbon mixture is cycled back to the contacting tower 670 through line 687, while most of the mixture is recovered as a separate heavy hydrocarbon product.

In one aspect, the lean oil is cooled prior to contact with the cleaned gas stream 664. Cooling the lean oil down to temperatures of about 0° F. to 35° F. can improve the recovery of C₃ hydrocarbons as well as C₂ components. At the same time, the cooled lean oil may have a propensity to co-adsorb significant methane and, at times, a portion of the carbon dioxide components. Therefore, it is preferred that the lean oil be maintained at temperatures of about −10° F. to −30° F.

Another method proposed herein for removing heavy hydrocarbons upstream of an acid gas removal system involves the use of membranes. Membranes operate by the permeation of selected molecules from high pressure to low pressure across a polymeric material.

Membrane contactors are known as a means for scrubbing acid gases. For example, U.S. Pat. No. 7,442,233 discusses the use of a bulk acid gas removal membrane (seen at 66 in FIG. 3 of the '233 patent) for the partial removal of carbon dioxide prior to amine treatment. Such a process is said to be useful if the CO₂ content of the natural gas stream is at least 10% by volume. It is noted that the '233 patent does not use a membrane contactor to capture heavy hydrocarbons; instead, the membrane captures a portion of the carbon dioxide content of a natural gas stream, with the acid gas stream then undergoing subsequent amine treatment for the complete removal of CO₂. Some heavy hydrocarbons are captured upstream of the membrane using thermal or, perhaps, pressure swing adsorption, but are not gathered for a commercial product. In fact, the '233 patent states in column 12 that in cases where the raw natural gas feed stream has a low heavy hydrocarbon content, the initial swing adsorption step can be skipped and the raw natural gas feed stream can be sent directly to amine treatment.

Applicant has discerned that certain types of membranes such as rubbery membranes preferentially adsorb, dissolve and permeate heavy hydrocarbons relative to lighter ones. Such membranes may be installed upstream of a cryogenic distillation process to remove heavy hydrocarbons. Examples of rubbery membranes for the capture of heavy hydrocarbons include nitrile rubber, neoprene, polydimethylsiloxane (silicone rubber), chlorosulfonated polyethylene, polysiliconecarbonate copolymers, fluoroelastomers, plasticized polyvinylchloride, polyurethane, cis-polybutadiene, cis-polyisoprene, poly(butene-1), polystyrene-butadiene copolymers, styrene/butadiene/styrene block copolymers, styrene/ethylene/butylene block copolymers, and thermoplastic polyolefin elastomers.

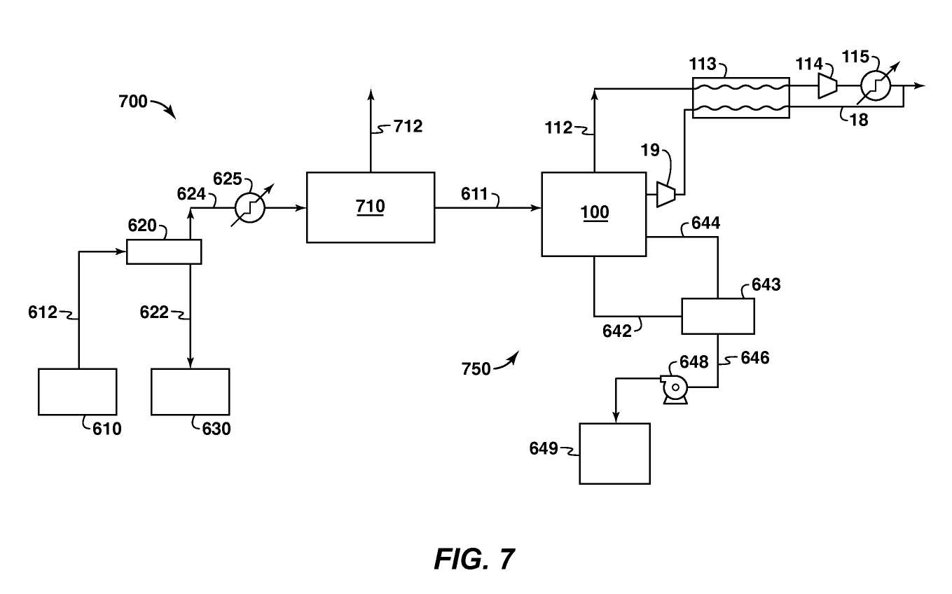

FIG. 7 presents a schematic diagram of a gas processing facility 700 in an alternate embodiment. This facility is generally in accordance with the gas processing facility 600 of FIG. 6A. In this respect, a dehydrated gas stream 624 is chilled and then delivered to an acid gas removal system 750 as sour gas through line 611. However, in this instance instead of using a physical solvent system 605 along with contacting tower 670, a membrane contactor 710 is used. The membrane contactor preferentially adsorbs heavy hydrocarbons from the dehydrated gas stream 624. A permeate 712 is released from the membrane contactor 710 at low pressure, such as near atmospheric pressure. The permeate 712 contains primarily heavy hydrocarbons that are captured for sale.

It is acknowledged that with membranes that preferentially adsorb heavy hydrocarbons relative to methane, some CO₂ and H₂S may also permeate through the rubbery polymeric materials. Therefore, heavy hydrocarbons captured with a membrane will likely be contaminated with CO₂ and, if initially present in the production gas 612, H₂S. This means that the permeate 712 will likely contain acid gases and may require further processing.

Another method proposed herein for removing heavy hydrocarbons upstream of an acid gas removal system is a process called adsorptive kinetic separations, or AKS. AKS employs a relatively new class of solid adsorbents that relies upon the rate at which certain species are adsorbed onto structured adsorbents relative to other species. This is in contrast to traditional equilibrium-controlled swing adsorption processes wherein the selectivity is primarily imparted by the equilibrium adsorption properties of the solid adsorbent. In the latter case, the competitive adsorption isotherm of the light product in the micropores or free volume of the adsorbent is not favored.

In a kinetically controlled swing adsorption process, selectivity is imparted primarily by the diffusional properties of the adsorbent and by the transport diffusion coefficient in the micropores. The adsorbent has a “kinetic selectivity” for two or more gas components. As used herein, the term “kinetic selectivity” is defined as the ratio of single component diffusion coefficients, D (in m²/sec), for two different species. These single component diffusion coefficients are also known as the Stefan-Maxwell transport diffusion coefficients that are measured for a given adsorbent for a given pure gas component. Therefore, for example, the kinetic selectivity for a particular adsorbent for component A with respect to component B would be equal to D_{A}/D_{B}. The single component diffusion coefficients for a material can be determined by tests well known in the adsorptive materials art.

The preferred way to measure the kinetic diffusion coefficient is with a frequency response technique described by Reyes, et al. in “Frequency Modulation Methods for Diffusion and Adsorption Measurements in Porous Solids”, J. Phys. Chem. B. 101, pp. 614-622 (1997). In a kinetically controlled separation, it is preferred that kinetic selectivity (i.e., D_{A}/D_{B}) of the selected adsorbent for the first component (e.g., Component A) with respect to the second component (e.g., Component B) be greater than 5, more preferably greater than 20, and even more preferably greater than 50.

It is preferred that the adsorbent be a zeolite material. Non-limiting examples of zeolites having appropriate pore sizes for the removal of heavy hydrocarbons include MFI, faujasite, MCM-41 and Beta. It is preferred that the Si/Al ratio of zeolites utilized in an embodiment of a process of the present invention for heavy hydrocarbon removal be from about 20 to about 1,000, preferably from about 200 to about 1,000 in order to prevent excessive fouling of the adsorbent. Additional technical information about the use of adsorptive kinetic separation for the separation of hydrocarbon gas components is U.S. Pat. Publ. No. 2008/0282884, the entire disclosure of which is incorporated herein by reference.

In the current adsorptive kinetic separation (AKS) application, the heavier (slower) hydrocarbons will be retained by the adsorbent. This means that they will be recovered at a lower pressure. The light components, i.e., methane, N₂, and CO₂, on the other hand, will be released from the adsorbent at intermediate pressure as the sour gas stream. The sour gas stream is chilled and then sent to the acid gas removal system.

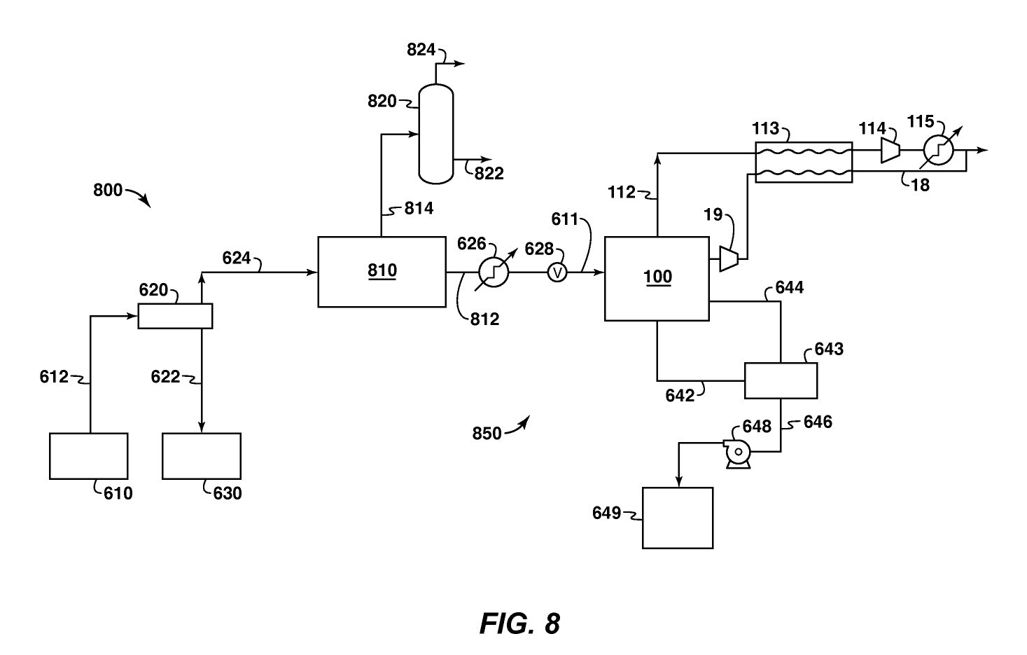

FIG. 8 presents a schematic diagram of a gas processing facility 800 employing an adsorptive kinetic separation process. This facility 800 operates generally in accordance with the gas processing facility 600 of FIG. 6A. In this respect, a dehydrated raw gas stream 624 is chilled and then delivered to an acid gas removal system 850 as a sour gas stream in line 611. However, instead of using a physical solvent contacting system 605 along with contacting tower 670 upstream of the acid gas removal system 850, an AKS solid adsorbent bed 810 is used. The adsorbent bed 810 preferentially adsorbs heavy hydrocarbons. A natural gas liquids stream 814 is then released from the solid adsorbent bed at low pressure.

The natural gas liquids stream 814 contains primarily heavy hydrocarbons, but also comprises some carbon dioxide. For this reason, a distillative process is preferably undertaken to separate carbon dioxide out of the natural gas liquids. A distilling vessel is shown at 820. The distilling vessel 820 may be, for example, a trayed or packed column used as a contaminant clean-up system. Carbon dioxide gas is released through an overhead line 824. Line 824 is preferably merged with acid gas line 646 for acid gas injection into reservoir 649. Heavy hydrocarbons exit the vessel 820 through a bottom line 822 where they are captured for sale.

It is noted that the adsorptive kinetic separations process of system 800 may be more beneficial for recovering heavy hydrocarbons from natural gas streams produced under a large excess of pressure. In this situation, the sour gas in line 611 has adequate pressure to be processed by the cryogenic distillation tower 100. An example of excess pressure would be pressure greater than 400 psig.

The adsorbent bed 810 releases a light gas stream 812. The light gases are comprised primarily of methane and carbon dioxide. It is preferred that cooling be provided to the light gases 812 before entrance into the cryogenic distillation tower 100. In the illustrative gas processing facility 800, light gases 812 are passed through a refrigeration unit 626, and then through an expansion device 628. The expansion device 628 may be, for example, a Joule-Thompson (“J-T”) valve. Preferably, at least partial liquefaction of the light gases 812 is accomplished in connection with the cooling. A cooled sour gas stream is generated at 611 which is directed to the acid gas removal system 850.

Another method proposed herein for removing heavy hydrocarbons upstream of an acid gas removal system is a process called extractive distillation. Extractive distillation utilizes a solvent along with at least two distillation columns to facilitate the separation of close-boiling components.

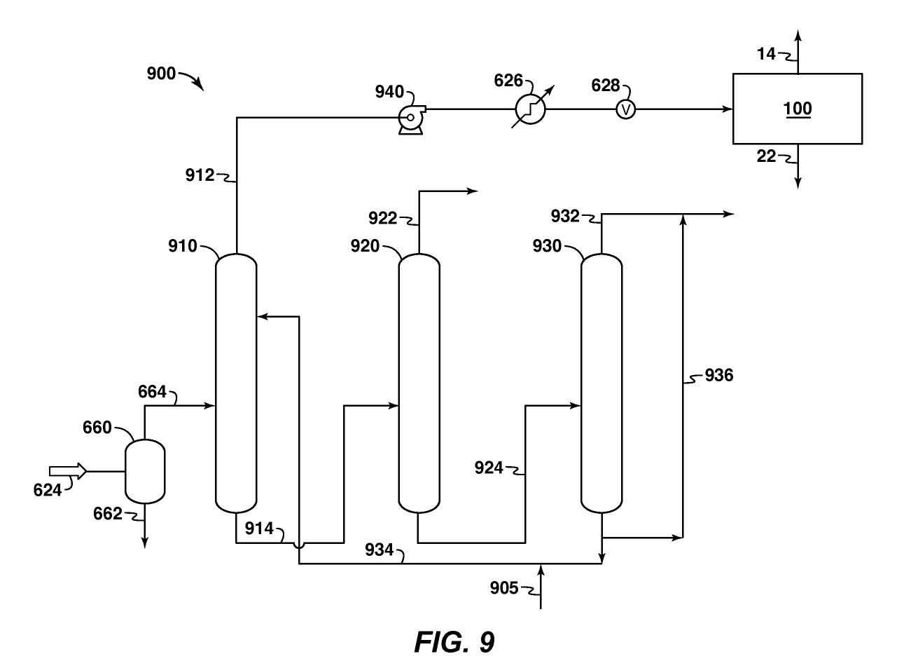

FIG. 9 provides a schematic view of a gas processing facility 900 in which an extractive distillation system 900 is employed. The extractive distillation system 900 is shown upstream of the cryogenic distillation tower 100. At the beginning, a dehydrated gas stream 624 is seen entering an inlet separator 660. The inlet separator 660 serves to remove any condensed hydrocarbons. The inlet separator 660 may also separate out liquid impurities such as drilling fluids. Some particle filtration may also take place. It is understood that it is desirable to keep the gas stream 624 as clean as possible so as to prevent foaming of liquid solvent during the acid gas treatment process.

Liquid impurities drop out of the bottom of the inlet separator 660. An impurities stream is seen at 662. At the same time, gas exits from the top of the inlet separator 660. A cleaned gas stream is seen at 664. The cleaned gas stream 664 has both light and heavy hydrocarbons. The cleaned gas stream 664 also has acid gases such as carbon dioxide.

The cleaned gas stream 664 enters an extractive distillation column. In the illustrative arrangement of FIG. 9, two solvent recovery columns 910, 920 are shown. However, it is understood that more than two columns may be employed.

The extractive distillation column 910 mixes a solvent with the cleaned gas stream 664 in a vessel. In the first column 910, the temperature is generally −100° to 50° F. In the first column 910, solvent absorbs heavy hydrocarbons, causing the solvent to leave the column 910 as a heavy hydrocarbons bottoms stream 914. It will also contain much of the CO₂. At the same time, light hydrocarbons exit the column 910 through an overhead stream 912.

The heavy hydrocarbons bottoms stream 914 enters the CO₂ removal column 920. The temperature in the second column 920 is generally 0° to 250° F., which is higher than the temperature in the first column 910. In the second column 920, solvent and heavy hydrocarbons again leave the column 920 as a heavy hydrocarbons bottoms stream 924. At the same time, ethane and carbon dioxide exit the second column 920 as an overhead carbon dioxide stream 922. The overhead stream 922 may be optionally merged into the overhead stream 912, though it is preferred that they be kept separate. Preferably, overhead stream 922 is sent for disposal as shown in FIG. 9. If the CO₂ content in the overhead stream 912 is too high for pipeline specification, the light gases in overhead stream 912 are preferably re-pressurized through compressor 940, and then chilled through refrigeration unit 626 and J-T valve 628. The re-pressurized and partially liquefied light components then enter the cryogenic distillation tower 100. The tower 100 operates to separate acid gases from the methane, generating an overhead methane stream 12 and a bottom acid gas stream 22.

In one aspect, the overhead carbon dioxide stream 922 may be delivered directly to the acid gas bottoms stream 22.

A final column 930 is shown in FIG. 9. The final column 930 is an additive recovery column. The additive recovery column 930 uses distillative principles to separate heavy hydrocarbon components, known as “natural gas liquids,” from solvent. The temperature in the third column 930 is generally 80° F. to 350° F., which is higher than the temperature in the second column 930. The natural gas liquids exit the column 930 through line 932 and are taken to a treating unit for the removal of any remaining H₂S and CO₂. This treating unit may be a liquid-liquid extractor in which amine is used for H₂S/CO₂ removal, for example.

Solvent leaves the additive recovery column 930 as a bottom solvent stream 934. The bottom solvent stream 934 represents a regenerated additive. A majority of the bottom solvent stream 934 is reintroduced into the first column 910 for the extractive distillation process. Excess solvent from stream 934 can optionally be combined with the natural gas liquid stream 932 for treatment via line 936.

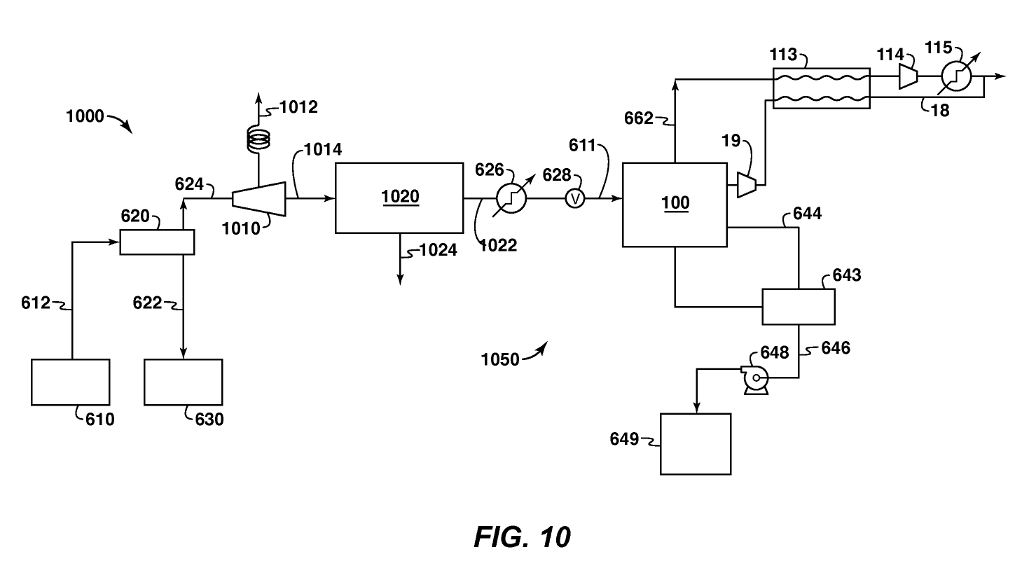

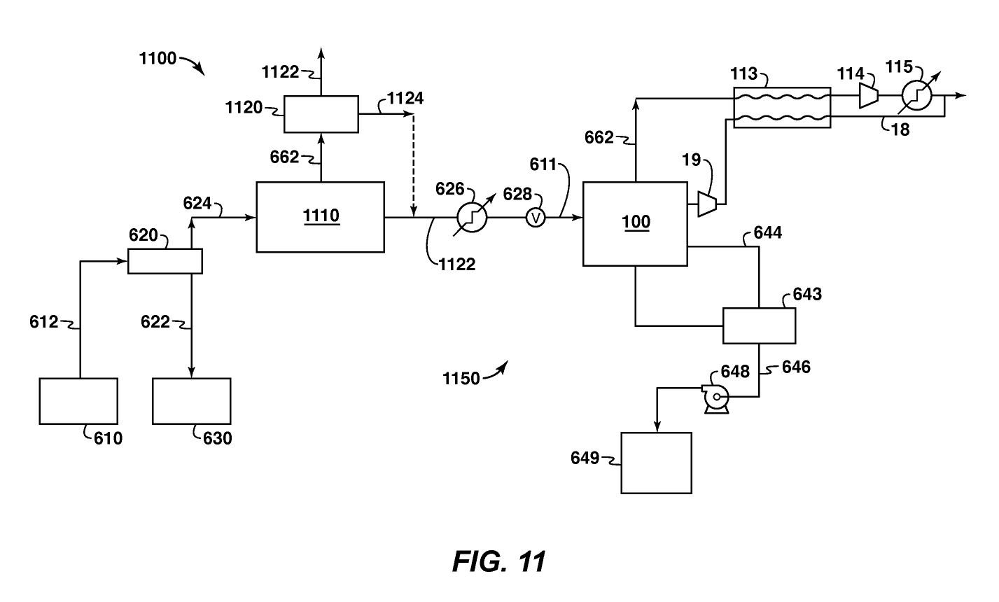

Additional methods for removing heavy hydrocarbons from a sour gas stream are shown in FIGS. 10 and 11. First, FIG. 10 presents a schematic view of a gas processing facility 1000 that utilizes a turbo-expander upstream of a cryogenic distillation tower 100. A turbo-expander is seen at 1010.

The gas processing facility 1000 is generally in accordance with the gas processing facility 600 of FIG. 6A. In this respect, a dehydrated gas stream 624 is chilled and then delivered to an acid gas removal system 1050 as a sour gas stream in line 611. However, in this instance instead of using a physical solvent system 605 along with contacting tower 670, a turbo-expander 1010 followed by a separator 1020 is used.

A turbo-expander is a centrifugal or axial flow turbine through which a high pressure gas is expanded. Turbo-expanders are typically used to produce work that may be used, for example, to drive a compressor. In this respect, turbo-expanders create a source of shaft work for processes like compression or refrigeration. In the present application, the turbo-expander 1010 is preferably used to generate electricity, indicated at line 1012.

Sour gas is released from the turbo-expander 1010 through line 1014. This gas 1014 is in a cooled state due to the drop in pressure created by the turbo-expander 1010. At least a portion of the cooled gas 1014 may be liquefied, particularly the heavy hydrocarbon components, but the temperature should be maintained above the CO₂ solidification temperature. The cooled gas 1014 is delivered to the separator, shown at 1020. The separator 1020 separates the cooled gas 1014 into heavy hydrocarbon and light gas components. Heavy hydrocarbons, which also contain CO₂, are dropped from the separator 1020 through line 1024 and are captured for sale. Light hydrocarbons containing carbon dioxide are passed through line 1022 and are delivered to a distillation tower, such as tower 100 of FIG. 1.

It is preferred that additional cooling be provided to the light gases 1022 before entrance into the cryogenic distillation tower 100. In the illustrative gas processing facility 1000, light gases 1022 are passed through a refrigeration unit 626. The refrigeration unit 626 chills the light gases 1022 down to a temperature of about −30° F. to −40° F. The refrigeration unit 626 may be, for example, an ethylene or a propane refrigerator.

The light gases 1022 are next preferably moved through an expansion device 628, if sufficient pressure is available. The expansion device 628 may be, for example, a Joule-Thompson (“J-T”) valve. The expansion device 628 serves as an expander to obtain further cooling of the light gases 1022. The expansion device 628 further reduces the temperature of the light gases 1022 down to, for example, about −70° F. to −80° F. Preferably, at least partial liquefaction of the gases 1022 is also accomplished. A cooled sour gas stream is indicated at line 611. The sour gas in line 611 is directed to the acid gas removal system 1050.

FIG. 11 presents a schematic view of another gas processing facility 1100 that separates heavy hydrocarbons from a light gas stream upstream of a cryogenic distillation tower 100. In this arrangement, the gas processing facility 1100 utilizes a cyclonic device as part of the separation process. A cyclonic device is shown schematically at 1110.

The gas processing facility 1100 is generally in accordance with the gas processing facility 600 of FIG. 6A. In this respect, a dehydrated gas stream 624 is chilled and then delivered to an acid gas removal system 1150 through the sour gas in line 611. However, in this instance instead of using a physical solvent system 605 along with contacting tower 670, a cyclonic device 1110 is used. The cyclonic device 1110 provides partial separation of heavy hydrocarbons from the dehydrated gas stream 624.

A cyclonic device is typically an elongated, conical device that uses rotational effects and gravity to separate materials. Cyclonic devices are most commonly used for removing particulates from an air, gas or water stream. Cyclonic devices operate on the principle of vortex separation. They are able to achieve effective separation without the use of filters. In the present application, the cyclonic device 1110 provides initial partial separation of heavy hydrocarbons from light gases. Typically, a pressure drop of about 25% is effectuated within the cyclonic device 1110.

One example of a suitable cyclonic device 1110 is the TWISTER™ Supersonic Separator available from Twister, B.V of The Netherlands. The TWISTER™ is a compact tubular device that receives gas and accelerates it to supersonic velocities in a matter of seconds, or less. The TWISTER™ may be used to separate water and/or heavy hydrocarbons from light gases. Another suitable example of a cyclonic device is the Vortisep. The Vortisep is a vortex tube that may be used to separate heavy hydrocarbons or water from natural gas. Vortex tubes operate on Ranque-Hilsch physics. A fluid stream is injected tangentially into the center of an elongated tube. The fluid rotates within the tube, with a first fluid component exiting at one end as a warm fluid, and a second fluid component exiting at an opposite end as a cool fluid.

As seen in FIG. 11, the cyclonic device 1110 releases a light gas 1122. The light gas 1122 comprises light hydrocarbons, primarily methane, and acid gases such as CO₂. As described above in connection with FIG. 10, the light gas 1122 is chilled before delivery to the cryogenic distillation tower 100 as a sour gas stream in line 611.

The cyclonic device 1110 also releases a heavy fluid stream 1112. The heavy fluid stream 1112 contains the heavy hydrocarbons that were originally part of the dehydrated gas stream 624. Because the cyclonic device 1110 is not completely effective for the separation of fluid components, the heavy fluid stream 1112 will also contain some light hydrocarbons and carbon dioxide. Therefore, the heavy fluid stream 1112 is delivered to a fluid separator 1120 for further processing. The fluid separator 1120 may be, for example, a condensate stabilizer.

The fluid separator 1120 releases heavy hydrocarbons through line 1126. The heavy hydrocarbons in line 1126 are captured for sale. The fluid separator 1120 also releases light gases indicated at line 1124. The light gases 1124 include light hydrocarbons, primarily methane, and acid gases. The light gases in line 1124 are preferably merged with the light gases in line 1122 prior to cooling. Alternatively, the light gases in line 1124 are compressed and combined with the bottoms acid gas line 646 for injection or disposal.

Two additional methods that may be used for the removal of heavy hydrocarbons upstream of a cryogenic distillation tower involve the use of an adsorbent bed. One method employs thermal swing adsorption, while the other utilizes pressure swing adsorption. In each case, the adsorbent material is regenerated for re-use.

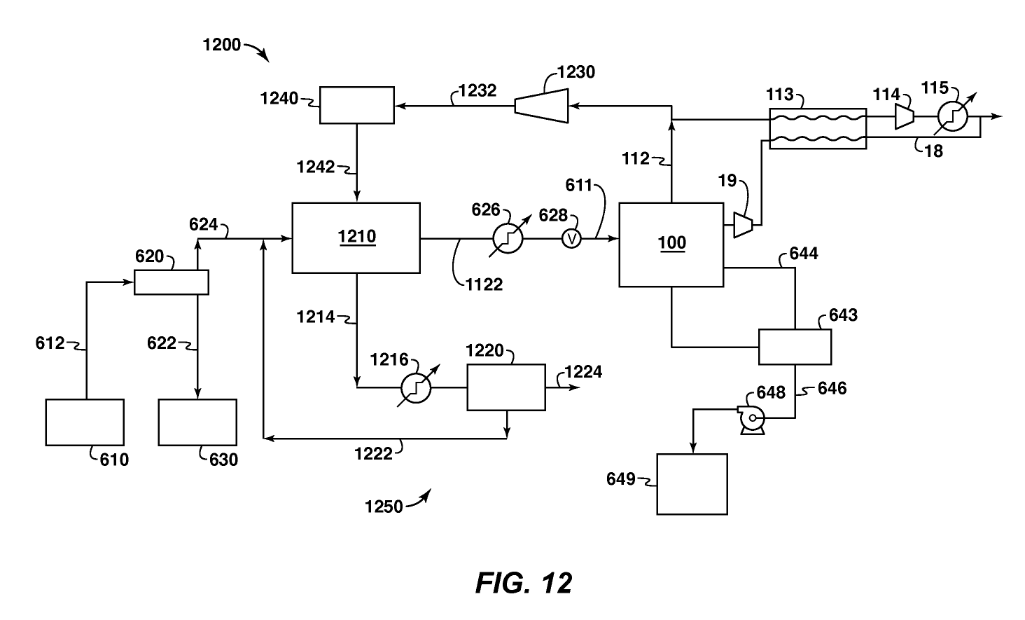

FIG. 12 provides a schematic diagram of a gas processing facility 1200 that uses thermal swing adsorption for the removal of heavy hydrocarbons. The gas processing facility 1200 generally operates in accordance with gas processing facility 600 of FIG. 6. In this respect, a dehydrated gas stream 624 is chilled and then delivered to an acid gas removal system 1250 through sour gas stream in line 611. However, instead of using a physical solvent system 605 along with contacting tower 670, a thermal swing adsorption system 1210 is used. The thermal swing adsorption system 1210 provides at least partial separation of heavy hydrocarbons from the dehydrated gas stream 624.

The thermal swing adsorption system 1210 uses an adsorbent bed to selectively adsorb heavy hydrocarbons, while passing light gases. Light gases are shown being released at line 1212. The light gases 1212 contain carbon dioxide, and are delivered to a distillation tower, such as tower 100 of FIG. 1.

It is again preferred that additional cooling be provided to the light gases 1212 before entrance into the cryogenic distillation tower 100. In the illustrative gas processing facility 1000, light gases 1212 are passed through a refrigeration unit 626, and then through an expansion device 628. The expansion device 628 may be, for example, a Joule-Thompson (“J-T”) valve. Preferably, at least partial liquefaction of the gases 1212 is accomplished in connection with the cooling. A cooled sour gas stream is generated and delivered through line 611 which is directed to the acid gas removal system 1250.

Referring again to the thermal swing adsorption system 1210, the adsorbent bed in the thermal swing adsorption system 1210 is preferably a molecular sieve fabricated from zeolite. However, other adsorbent beds such as a bed filled with silica gel may be employed. Those of ordinary skill in the art of hydrocarbon gas separation will understand that the selection of the adsorbent bed will typically depend on the composition of the heavy hydrocarbons. For instance, molecular sieve beds may be most effective at removing C₂ to C₄ components, while silica gel beds may be most effective at removing C₅+ heavy hydrocarbons.

In operation, the adsorbent bed resides in a pressurized chamber. The adsorbent bed receives the dehydrated gas stream 624 and adsorbs heavy hydrocarbons along with a certain amount of carbon dioxide. The adsorbent bed in the adsorption system 1210 will be replaced once the bed becomes saturated with heavy hydrocarbons. The heavy hydrocarbons (and associated acid gases) will be released from the bed in response to heating the bed using a heated dry gas. Suitable gases include a portion of the overhead methane stream 112, heated nitrogen, or a fuel gas otherwise available. As seen in FIG. 12, a heavy hydrocarbon fluid stream is released through line 1214.

Block 1240 depicts a regeneration heater for an adsorbent bed. The regeneration chamber 1240 receives a dry gas 1232. In the arrangement of FIG. 12, the dry gas is received from the overhead methane stream 112. The overhead methane stream 112 comprises primarily methane, but may also include trace amounts of nitrogen and helium. The overhead methane stream 112 is preferably compressed to raise the pressure of the gas in the regeneration heater. A pressure booster is shown at 1230. However, regeneration primarily takes place through increased temperature.

Five to ten percent of the overhead methane stream 112 may be required for adequate regeneration. The regeneration chamber 1240 releases a regenerated fluid stream 1242. The regenerated fluid stream 1242 is sent to the adsorption system 1210.

For a thermal swing regeneration cycle, at least three adsorbent beds are preferably required: a first bed is used for adsorption in the adsorption system 1210; a second bed is undergoing regeneration; and a third bed has already been regenerated and is in reserve for use in the adsorption system 1210 when the first bed becomes fully saturated with heavy hydrocarbons. Thus, a minimum of three beds is used in parallel for a more efficient operation. These beds may be packed, for example, with silica gel.

As noted, the adsorption system 1210 releases a heavy hydrocarbon fluid stream 1214. The heavy hydrocarbon fluid stream 1214 comprises primarily heavy hydrocarbons, but will most likely also contain carbon dioxide. For this reason, it is desirable to process the heavy hydrocarbon fluid stream 1214 before the heavy hydrocarbons are released for sale.

In one aspect, the heavy hydrocarbon fluid stream 1214 is cooled using a refrigeration unit 1216. This causes at least a partial liquefaction of the heavy hydrocarbons within the heavy hydrocarbon fluid stream 1214. The heavy hydrocarbon fluid stream 1214 is then introduced into a separator 1220. The separator 1220 is preferably a gravity separator that separates heavy hydrocarbons from light gases. Light gases are released from the top of the separator 1220 (shown schematically at line 1222). The light gases released from the separator 1220 in line 1222 are returned to the dehydrated gas stream 624. At the same time, heavy hydrocarbons are released from the bottom of the separator 1220 (shown schematically at line 1224).

It is noted that the gas processing facility 1200 may not include a dehydration unit 620. In that instance, water will be dropped out of the adsorption system 1210 with the heavy hydrocarbon fluid stream 1214. The water will further be dropped out of the separator 1220 with the heavy hydrocarbons in line 1224. Separation of water from the heavy hydrocarbons using, for example, a cyclonic device or a floatation separator (not shown) would preferably then be employed.

In some embodiments, a combination of solid adsorbents could be used for the removal of different heavy hydrocarbon components. For example, silica gel could be used to recover heavier heavy hydrocarbon components, i.e., C₅+, from associated gas, while the lighter heavy hydrocarbons, i.e., the C₂-C₄ components, would be removed using molecular sieves fabricated from zeolite. Such a combination of solid adsorbents helps to prevent heavy hydrocarbons from remaining in the gas phase and ultimately ending up with the acid gas bottoms stream 642.

In one application, gas from the separator 1220 may be burned to drive a turbine (not shown). The turbine, in turn, may drive an open loop compressor (such as compressor 176 of FIG. 1). The regeneration gas heater 1240 may be further integrated into the acid gas removal process by taking waste heat from such a turbine and using it to pre-heat the regeneration gas (such as in line 1232) for the heavy hydrocarbon recovery process. Similarly, gas from the overhead compressor 114 or the overhead chiller 115 may be used to pre-heat the regeneration gas used for the heavy hydrocarbon recovery process.

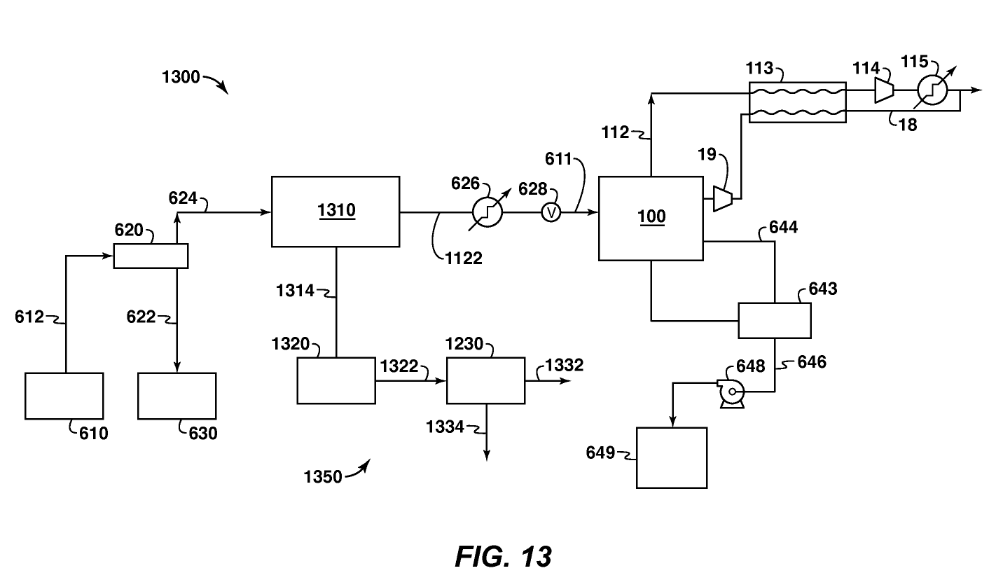

As noted, pressure swing adsorption may also be used to remove heavy hydrocarbons upstream of an acid gas removal facility. FIG. 13 provides a schematic diagram of a gas processing facility 1300 that uses pressure swing adsorption for the removal of heavy hydrocarbons. The gas processing facility 1300 generally operates in accordance with gas processing facility 600 of FIG. 6. In this respect, a dehydrated gas stream 624 is chilled and then delivered to an acid gas removal system 1350 through a sour gas stream in line 611. However, instead of using a physical solvent contacting system 605 along with contacting tower 670, a pressure swing adsorption system 1310 is used. The pressure swing adsorption system 1310 provides at least partial separation of heavy hydrocarbons from the dehydrated gas stream 624.

As with the thermal swing adsorption system 1210, the pressure swing adsorption system 1310 uses an adsorbent bed to selectively adsorb heavy hydrocarbons while releasing light gases. The adsorbent bed is preferably a molecular sieve fabricated from zeolite. However, other adsorbent beds such as a bed fabricated from silica gel may be employed. Those of ordinary skill in the art of hydrocarbon gas separation will again understand that the selection of the adsorbent bed will typically depend on the composition of the heavy hydrocarbons.

As seen in FIG. 13, the adsorption system 1310 releases light gases through line 1312. The light gases 1312 are carried through a refrigeration unit 626 and then, preferably, through a Joule-Thompson valve 628 before entry into the cryogenic distillation system 100. At the same time, a heavy hydrocarbon fluid stream is released from the adsorbent bed through line 1314.

In operation, the adsorbent bed in the adsorption system 1310 resides in a pressurized chamber. The adsorbent bed receives the dehydrated gas stream 624 and adsorbs heavy hydrocarbons along with a certain amount of carbon dioxide. The adsorbent bed in the adsorption system 1310 will be replaced once the bed becomes saturated with heavy hydrocarbons. The heavy hydrocarbons (and associated acid gases) will be released from the bed in response to reducing pressure in the pressurized chamber. A heavy hydrocarbon fluid stream is shown at 1314.

In most cases, reducing the pressure in the pressurized chamber down to ambient pressure will cause a majority of the heavy hydrocarbons and associated carbon dioxide in the heavy hydrocarbon fluid stream 1314 to be released from the adsorbent bed. In some extreme cases, however, the gas processing facility 1300 may be aided by the use of a vacuum chamber to apply sub-ambient pressure to the heavy hydrocarbon fluid stream 1314. This is indicated at block 1320. In the presence of lower pressure, heavy hydrocarbons desorb from the solid matrix making up the adsorbent bed.

The heavy hydrocarbon fluid stream 1314 comprises primarily heavy hydrocarbons, but will most likely also contain carbon dioxide. For this reason, it is desirable to process the heavy hydrocarbon fluid stream 1314 before the heavy hydrocarbons are released for sale. Heavy hydrocarbons and associated carbon dioxide in the heavy hydrocarbon fluid stream 1314 are advanced towards a separator 1330 through line 1322.

In one aspect, the heavy hydrocarbon fluid stream 1314 is cooled using a refrigeration unit (not shown). This causes at least a partial liquefaction of the heavy hydrocarbons within the heavy hydrocarbon fluid stream 1314. However, in the gas processing facility 1300 that uses pressure swing adsorption, a cooling system is normally unnecessary as the pressure drop associated with releasing the heavy hydrocarbon fluid stream 1314 from the adsorption system 1310 will cause a corresponding reduction in temperature.

The separator 1330 is preferably a gravity separator that separates heavy hydrocarbons from light gases. Light gases are released from the top of the separator 1330 (shown schematically at line 1332). The light gases (primarily CO₂) released from the separator 1330 in line 1332 are preferably merged with the acid gas bottoms stream 642. At the same time, heavy hydrocarbons are released from the bottom (shown schematically at line 1334). The heavy hydrocarbons in line 1334 are sent for commercial sale.

As with the thermal swing adsorption system 1210, the pressure swing adsorption system 1310 may rely on a plurality of beds in parallel. A first bed is used for adsorption in the adsorption system 1310. This is known as a service bed. A second bed undergoes regeneration through pressure reduction. A third bed has already been regenerated and is in reserve for use in the adsorption system 1310 when the first bed becomes fully saturated. Thus, a minimum of three beds may be used in parallel for a more efficient operation. These beds may be packed, for example, with activated carbons or molecular sieves.

In some embodiments, a combination of solid adsorbents may be used for the removal of different heavy hydrocarbon components. For example, molecular sieves fabricated from zeolite may be used to remove lighter heavy hydrocarbons, i.e., the C₂-C₄ components, from associated methane. Silica gel beds may be used to recover heavier heavy hydrocarbon components, i.e., C₅+, from associated gas. Using a combination of adsorbent beds helps to prevent heavy hydrocarbons from remaining in the gas phase and ultimately ending up with the acid gas bottoms stream 642.

In comparison to thermal swing regeneration, pressure swing regeneration has the benefit of not being as prone to hydrocarbon decomposition or coke formation. However, as with thermal swing adsorption process, the pressure swing adsorption process is more adept at recovering the heavier components of a heavy hydrocarbon stream. The recovery of C₂ to C₄ component will not generally be as high, though some value can be extracted from these hydrocarbons 1314.

The pressure swing adsorption system 1310 may be a rapid cycle pressure swing adsorption system. In the so-called “rapid cycle” processes, cycle times can be as small as a few seconds.

As can be seen, a number of methods may be used to remove heavy hydrocarbons in connection with an acid gas removal process. Generally, the method chosen is dependent on the condition of the raw natural gas, or the gas to be treated. For example, if the heavy hydrocarbon concentration is in the range of 1 to 5% and the CO₂ concentration is less than 20%, then absorption with a physical solvent upstream of the distillation tower may be preferable.

In certain instances, such as when the physical solvent is sulfolane, Selexol, or perhaps refrigerated methanol, the solvent will incidentally co-absorb a certain amount of methane and CO₂. However, these light gas components come out in differing amounts in the different flash stages. By clever integration with the acid gas removal system, advantage can be taken of the partial separation that the solvent affords.

If the heavy hydrocarbon content includes benzene (C₆) or heavier hydrocarbons, concern might exist that these heavy components will freeze up in a cryogenic distillation column. This would be a concern even if the overall heavy hydrocarbon content is less than 2%. In this case, the operator may choose to employ the extractive distillation process, which would avoid freezing of these heavy components as well as provide a mechanism for their recovery.

The lean oil process and the adsorptive kinetic separation process would preferably be used for conditions of relatively low CO₂ content, and high hydrocarbon content.

In some instances the operator may choose to combine heavy hydrocarbon recovery methods to ensure that all heavy hydrocarbon components are removed. For example, the operator may choose to combine the membrane contactor 710 from the gas processing facility 700 of FIG. 7 with an extractive distillation system such as system 900 of FIG. 9. The extractive distillation system may be installed either prior to the cryogenic distillation tower or after the cryogenic distillation tower. In the latter instance, the extractive distillation system 900 receives the acid gas bottom stream 642 from the distillation tower 100.

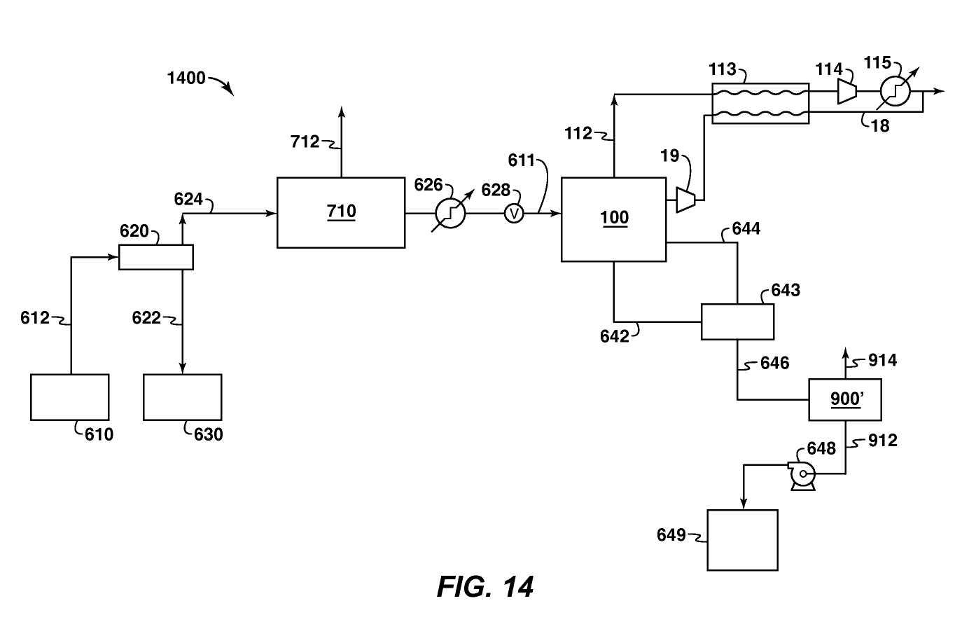

FIG. 14 presents a schematic view of a gas processing facility 1400 that demonstrates the integrated use of both an upstream heavy hydrocarbon removal system 1410 and a downstream heavy hydrocarbon removal system 1420. The gas processing facility 1400 is generally in accordance with the gas processing facilities described above. In this respect, the gas processing facility 1400 employs an upstream heavy hydrocarbon removal system 1410 that may be implemented as any of the systems described above in connection with FIGS. 6-13 for separating heavy hydrocarbons in a dehydrated gas stream 624 from light gases.

A heavy hydrocarbon stream 1412 is released from the upstream heavy hydrocarbon removal system 1410 at low pressure, such as near atmospheric pressure. The heavy hydrocarbon stream 1412 contains primarily heavy hydrocarbons that are captured for sale, but may also include small amounts of carbon dioxide. A light gas stream 610 is also passed from the upstream heavy hydrocarbon removal system 1410. The light gas stream 610 will primarily contain methane and carbon dioxide, but may also have traces of H₂S and other sulfur species, along with N₂. The light gas stream 610 is delivered to a cryogenic distillation tower (such as tower 100 of FIG. 1) for acid gas removal.

As described above, methane is released from the distillation tower 100 as an overhead methane stream 112. The overhead methane stream 112 will preferably comprise no more than about 2% carbon dioxide. At this percentage, the overhead methane stream 112 may be used as fuel gas or may be sold into certain markets as natural gas. Preferably, the overhead methane stream 112 is further processed to convert the methane gas therein into a liquid state for sale as LNG 116.

Acid gases are removed from the distillation tower 100 as a bottom liquefied acid gas stream 642. This liquid stream 642 may optionally be sent through a reboiler 643 where trace amounts of methane are redirected back into the tower 100 as gas stream 644. The remaining liquid is released through acid gas line 646.

In the gas processing facility 1400, the liquid in line 646 is comprised primarily of carbon dioxide and heavy hydrocarbons. Accordingly, the liquid in line 646 is directed to a downstream heavy hydrocarbon removal system 1420. The downstream heavy hydrocarbon removal system 1420 may be an extractive distillation facility, which may be set up in accordance with the facility 900 shown in FIG. 9, that is, the portion of the facility 900 that shows the columns 910, 920, 930 and associated lines and equipment. Additionally or alternatively, the downstream heavy hydrocarbon removal system 1420 may incorporate any of the other heavy hydrocarbon removal systems described above. The downstream heavy hydrocarbon removal system 1420 will separate the heavy hydrocarbons contained in the liquefied acid gas line 646 from carbon dioxide and other acid gases. A heavy hydrocarbon line is seen at 1414, while an acid gas line is seen at 1416. The acid gas in line 1416 is preferably passed through a pressure booster 648 and then injected into a reservoir 649.

While the downstream heavy hydrocarbon removal system 1420 of FIG. 14 is illustrated as being disposed on the acid gas bottoms from the reboiler 643, the heavy hydrocarbon removal system may be disposed on any suitable line downstream of the acid gas removal system 100. For example, a heavy hydrocarbon removal system 1420 may be disposed on the liquefied acid gas stream 642, on the gas stream 644, and/or on the acid gas line 646 as illustrated. The manner in which the downstream heavy hydrocarbon removal system 1420 is implemented may depend on a number of factors, including the composition of the different streams and the economies of the different hydrocarbon removal systems.

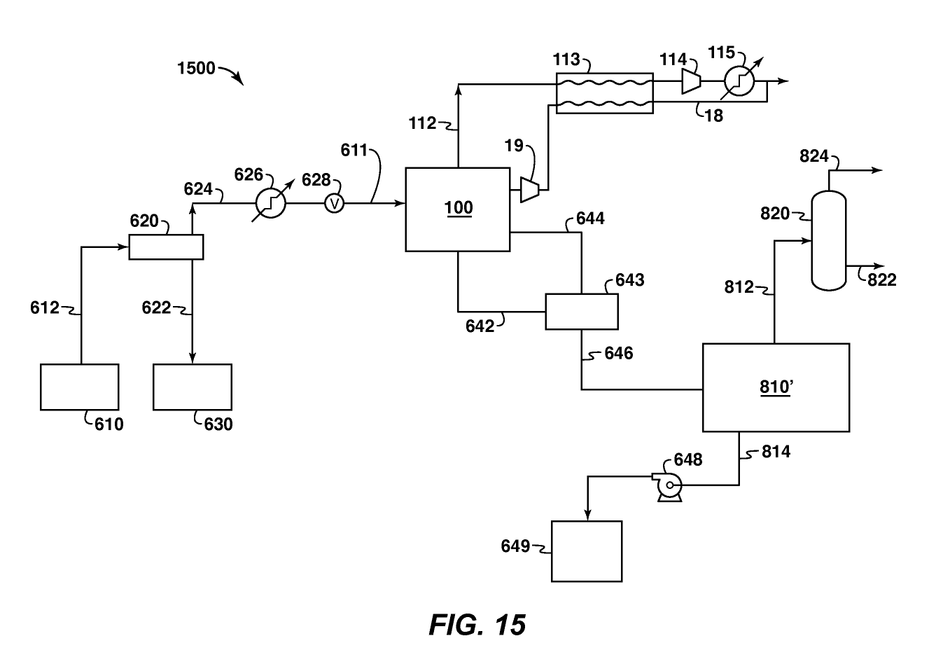

In another example, an adsorptive kinetic separation process is employed downstream of the cryogenic distillation tower. FIG. 15 presents a schematic diagram of a gas processing facility 1500 employing an adsorptive kinetic separation process. This facility 1500 is generally in accordance with the gas processing facility 800 of FIG. 8. However, in this instance instead of using an AKS solid adsorbent bed 800 upstream of an acid gas removal system 100, an AKS solid adsorbent bed 810′ is used downstream of the acid gas removal system 100.

It can be seen in FIG. 15 that acid gases are removed from the distillation tower 100 as a bottom liquefied acid gas stream 642. This liquid stream 642 may optionally be sent through a reboiler 643 where gas containing trace amounts of methane is redirected back into the tower 100 as gas stream 644. The remaining liquid comprised primarily of acid gases is released through acid gas line 646. The acid gases contain heavy hydrocarbons.

The acid gases from line 646 are delivered to the AKS solid adsorbent bed 810′. The acid gases remain cold and reside in a liquid phase as they pass through the bed 810′. Heavy hydrocarbons are removed from the acid gases and released through line 812 as a natural gas liquids stream 812. At the same time, acid gases drop out from the AKS solid adsorbent bed 810′ and are released as a bottoms acid gas stream 814.

Acid gas in the bottoms acid gas stream 814 remains in a primarily liquid phase. The liquefied acid gases in line 812 may be vaporized, depressurized, and then sent to a sulfur recovery unit (not shown). Alternatively, the liquefied acid gases in line 814 may be injected into a subsurface formation through one or more acid gas injection (AGI) wells as indicated by block 649. In this instance, the acid gas in line 646 is preferably passed through a pressure booster 648.

It is noted that the natural gas liquids stream 812 contains primarily heavy hydrocarbons, but also comprises carbon dioxide. For this reason, a distillative process is preferably undertaken to separate carbon dioxide out of the bottoms acid gas stream 814. A distilling vessel is shown at 820. Carbon dioxide gas is released from the distilling vessel 820 through an overhead line 824. Line 824 is preferably merged with bottoms acid gas stream 814 for acid gas injection into reservoir 649. Heavy hydrocarbons exit the vessel 820 through a bottom line 822 and are captured for sale.

Another method proposed herein for removing heavy hydrocarbons downstream of the acid gas removal system involves the use of membranes. As described above, membranes operate by the permeation of selected molecules from high pressure to low pressure across a polymeric material.

In one embodiment, rubbery membranes that preferentially adsorb, dissolve and permeate heavy hydrocarbons are used to recover those hydrocarbons from the bottoms stream of the acid gas removal process. The bottoms stream may optionally be vaporized prior to contacting it with the membranes.

In another embodiment, CO₂-selective membranes may be used on the bottoms stream to preferentially permeate the CO₂ to lower pressure, while retaining the hydrocarbons at high pressure. Membrane materials in this case include cellulose acetate, cellulose triacetate, polyimides, and other polymeric compounds. Other possible membrane materials include inorganic materials like zeolites, silicas, titano-silicates, aluminas, metallic organic frameworks (MOF's), and related materials. If the CO₂ is the permeate, it will need to be compressed for downhole disposal.

In some embodiments, the membranes may be in a “two-stage” configuration in which the permeate is compressed, and passed over another stage of membranes to improve overall recovery or purity of product.

In the interest of brevity and clarity, the description of available downstream heavy hydrocarbon recovery systems is provided here by reference to the prior discussion of upstream heavy hydrocarbon recovery systems. For example, it will be understood from the description above that the outlets from the downstream heavy hydrocarbon removal system 1420 will include a heavy hydrocarbon rich stream and a heavy hydrocarbon lean stream. Depending on the manner in which the downstream heavy hydrocarbon removal system 1420 is implemented, the heavy hydrocarbon lean stream may comprise different gases or liquids. For example, in the event that the downstream heavy hydrocarbon removal system 1420 is disposed on the gas stream 644, the downstream heavy hydrocarbon removal system 1420 may be adapted to allow the light hydrocarbon gas (e.g., methane) to pass through to the distillation tower 100 while separating the heavy hydrocarbons for other uses, such as for sale, combustion, or further processing. By extracting the heavy hydrocarbons from the gas stream 644 the distillation tower 100 may be constructed and/or operated more efficiently. With reference to the previous discussion of upstream heavy hydrocarbon removal system 1420, it will be understood that a variety of separation and purification may be used in connection with the primary heavy hydrocarbon separation units to constitute the heavy hydrocarbon removal system.

It is understood that the above-described methods for the removal of heavy hydrocarbons may be applied in connection with any acid gas removal process, not just a process that utilizes a “controlled freeze zone” tower. Other cryogenic distillation columns may be employed. Further, other cryogenic distillation processes such as bulk fractionation may be used. A bulk fractionation tower is similar to the CFZ tower 100 from FIG. 1, but does not have an intermediate freezing zone. A bulk fractionation tower typically operates at a higher pressure than a CFZ tower 100, thereby avoiding CO₂ solids formation. However, the overhead gas stream will contain significant amounts of CO₂. In any instance, utilizing a separate process for the removal of heavy hydrocarbons is desirable when the dehydrated gas stream 624 comprises greater than about 3% C₂ or heavier hydrocarbons.

Finally, if the heavy hydrocarbon concentration is less than 1 or 2 mol. percent, the operator may simply choose not to employ heavy hydrocarbon removal as the value of such a small quantity many not justify the added investment.

While it will be apparent that the inventions herein described are well calculated to achieve the benefits and advantages set forth above, it will be appreciated that the inventions are susceptible to modification, variation and change without departing from the spirit thereof Improvements to the operation of an acid gas removal process using a controlled freezing zone are provided. The improvements provide a design for the recovery of heavy hydrocarbons.

What is claimed is:

1. A system for removing acid gases from a sour gas stream, comprising:
an acid gas removal system for receiving the sour gas stream, wherein the acid gas removal system separates the sour gas stream into an overhead gas stream comprised primarily of methane, and a bottom acid gas stream comprised primarily of carbon dioxide; and
a heavy hydrocarbon removal system upstream of the acid gas removal system, wherein the heavy hydrocarbon removal system receives a raw gas stream comprising at least 5 mol. percent heavy hydrocarbon components, and generally separates the raw gas stream into a heavy hydrocarbon fluid stream and the sour gas stream without the use of a chemical solvent.

2. The system of claim 1, wherein the acid gas removal system is a cryogenic acid gas removal system comprising:
a cryogenic distillation tower; and
a heat exchanger for chilling the sour gas stream before entry into the distillation tower.

3. The system of claim 2, wherein:
the cryogenic distillation tower comprises a lower distillation zone and an intermediate controlled freezing zone that receives a cold liquid spray comprised primarily of methane, the tower receiving and then separating the raw gas stream into an overhead methane stream and the bottom acid gas stream; and
refrigeration equipment downstream of the cryogenic distillation tower for cooling the overhead methane stream and returning a portion of the overhead methane stream to the cryogenic distillation tower as the cold spray.

4. The system of claim 1, wherein the acid gas removal system is a bulk fractionation system.

5. The system of claim 2, wherein the heavy hydrocarbon removal system comprises a physical solvent system.

6. The system of claim 5, wherein the physical solvent system uses Sulfolane, Selexol, refrigerated methanol, lean oil, or refrigerated lean oil as a physical solvent.

7. The system of claim 5, wherein the physical solvent system comprises a counter-current contactor or a compact, co-current contactor for contacting physical solvent with the raw gas stream.

8. The system of claim 2, wherein the heavy hydrocarbon removal system comprises at least one membrane contactor.

9. The system of claim 8, further comprising:
an extractive distillation system downstream of the acid gas removal system for receiving the bottom acid gas stream and separating the bottom acid gas stream into a first fluid stream comprised primarily of carbon dioxide, and a second fluid stream comprised primarily of heavy hydrocarbon components.

10. The system of claim 1, wherein the heavy hydrocarbon removal system comprises at least one solid adsorbent bed for adsorbing at least some heavy hydrocarbon components and substantially passing light hydrocarbon components.

11. The system of claim 9, wherein the solid adsorbent bed (i) is fabricated from a zeolite material, or (ii) comprises at least one molecular sieve.

12. The system of claim 10, wherein:
the solid adsorbent bed adsorbs at least some carbon dioxide; and
the heavy hydrocarbon removal system further comprises a contaminant clean-up system for separating carbon dioxide from heavy hydrocarbon components.

13. The system of claim 10, wherein the at least one solid adsorbent bed system comprises at least three adsorbent beds, with:
a first of the at least three adsorbent beds being in service for adsorbing heavy hydrocarbon components;
a second of the at least three adsorbent beds undergoing regeneration; and
a third of the at least three adsorbent beds being held in reserve to replace the first of the at least three adsorbent beds.

14. The system of claim 13, wherein the regeneration is part of a pressure-swing adsorption process.

15. The system of claim 14, wherein the heavy hydrocarbon removal system further comprises a vacuum for applying sub-ambient pressure to desorb heavy hydrocarbon components from the first of the at least three adsorbent beds and to pressurize the heavy hydrocarbon fluid stream so that it may enter the separator.

16. The system of claim 13, wherein the regeneration is part of a thermal-swing adsorption process.

17. The system of claim 16, wherein:
the heavy hydrocarbon removal system further comprises a regeneration gas heater for (i) receiving a regenerating gas, (ii) heating the regeneration gas, and (iii) desorbing heavy hydrocarbons from the second adsorbent bed by applying heat from the heated regenerated gas to the second adsorbent bed; and
the regeneration gas releases a stream comprising heavy hydrocarbons to a separator that separates heavy hydrocarbons from light gases.

18. The system of claim 17, wherein the heavy hydrocarbon removal system further comprises a cooler for receiving the heavy hydrocarbon fluid stream and chilling the heavy hydrocarbon fluid stream before it enters the separator.

19. The system of claim 1, wherein the heavy hydrocarbon removal system comprises at least one adsorptive kinetic separations bed for substantially adsorbing methane and substantially passing heavy hydrocarbon components.

20. The system of claim 2, wherein the heavy hydrocarbon removal system comprises:
a turbo-expander; and
a separator for separating the raw gas stream into the heavy hydrocarbon fluid stream and the sour gas stream.

21. The system of claim 2, the heavy hydrocarbon removal system comprises:
a cyclonic device for separating the raw gas stream into the heavy hydrocarbon fluid stream and the sour gas stream; and
a contaminant clean-up system for receiving the heavy hydrocarbon fluid stream and separating the heavy hydrocarbon fluid stream into hydrocarbon components and carbon dioxide.

22. The system of claim 2, wherein the overhead gas stream comprises not only methane, but also helium, nitrogen, or combinations thereof.

23. The system of claim 2, wherein the bottom acid gas stream comprises not only carbon dioxide, but also hydrogen sulfide.

24. The system of claim 2, further comprising:
a dehydration apparatus for receiving the raw gas stream before it passes through the heavy hydrocarbon removal system, and separating the raw gas stream into a dehydrated acid gas stream and a stream comprised substantially of an aqueous fluid; and
wherein the acid gas stream received by the heavy hydrocarbon removal system is the dehydrated sour gas stream.

25. A system for removing acid gases from a sour gas stream, comprising:
an acid gas removal system for receiving the sour gas stream, the sour gas stream comprising at least about 5 mol. percent heavy hydrocarbon components, wherein the acid gas removal system separates the sour gas stream into an overhead gas stream comprised primarily of methane, and a bottom acid gas stream comprised primarily of carbon dioxide and heavy hydrocarbon components; and
a heavy hydrocarbon removal system downstream of the acid gas removal system, wherein the heavy hydrocarbon removal system receives at least a portion of the bottom acid gas stream and separates heavy hydrocarbons from the bottom acid gas stream without the use of a chemical solvent.

26. The system of claim 25, wherein the acid gas removal system is a cryogenic acid gas removal system comprising:
a cryogenic distillation tower; and
a heat exchanger for chilling the sour gas stream before entry into the distillation tower.

27. The system of claim 26, wherein:
the cryogenic distillation tower comprises a lower distillation zone and an intermediate controlled freezing zone that receives a cold liquid spray comprised primarily of methane, the tower receiving and then separating the raw gas stream into an overhead methane stream and a bottom liquefied acid gas stream; and
refrigeration equipment downstream of the cryogenic distillation tower for cooling the overhead methane stream and returning a portion of the overhead methane stream to the cryogenic distillation tower as liquid reflux.

28. The system of claim 25, wherein the heavy hydrocarbon removal system comprises at least one solid adsorbent bed for adsorbing at least some heavy hydrocarbon components from the bottom acid gas stream and substantially passing acid gases.

29. The system of claim 25, wherein the heavy hydrocarbon removal system comprises at least one adsorptive kinetic separations bed for separating heavy hydrocarbon components from at least one other component.

30. The system of claim 25, wherein the heavy hydrocarbon removal system comprises an extractive distillation system for receiving the bottom acid gas stream and separating the bottom acid gas stream into a first fluid stream comprised primarily of carbon dioxide, and a second fluid stream comprised primarily of heavy hydrocarbon components.

31. The system of claim 25, wherein the acid gases separated by the heavy hydrocarbon removal system comprise primarily carbon dioxide.

32. The system of claim 25, further comprising a reboiler on the bottom acid gas stream adapted to provide a reboiled vapor stream to the acid gas removal system, wherein the reboiled vapor stream comprises primarily light hydrocarbons and residual heavy hydrocarbons, and wherein heavy hydrocarbon removal system is adapted to separate the residual heavy hydrocarbons in the reboiled vapor stream.
